(19) United States
(12) Patent Application Publication
(10) Pub. No.: US 2024/0266610 A1
(43) Pub. Date: Aug. 8, 2024

(54) BATTERY, METHOD FOR MANUFACTURING BATTERY, AND CIRCUIT BOARD

(71) Applicant: Panasonic Intellectual Property Management Co., Ltd., Osaka (JP)

(72) Inventors: KAZUYOSHI HONDA, Osaka (JP); AKIRA KAWASE, Osaka (JP); KAZUHIRO MORIOKA, Osaka (JP); EIICHI KOGA, Hokkaido (JP); KOICHI HIRANO, Osaka (JP)

(21) Appl. No.: 18/638,739

(22) Filed: Apr. 18, 2024

Related U.S. Application Data
(63) Continuation of application No. PCT/JP2022/030060, filed on Aug. 5, 2022.

(30) Foreign Application Priority Data
Nov. 16, 2021 (JP) 2021-186454

(51) Int. Cl. H01M 10/0585; H01M 10/052

(52) U.S. Cl. CPC H01M 10/0585; H01M 10/052

(57) ABSTRACT

A battery includes: a power generation element including a plurality of battery cells each having an electrode layer, a counter electrode layer, and a solid electrolyte layer located between the electrode layer and the counter electrode layer, the plurality of battery cells being laminated while being connected in parallel; an electrode insulating member; and a counter electrode conductive member, in which each of the plurality of battery cells is provided with a through hole penetrating in a direction of lamination, the electrode insulating member covers the electrode layer of each of the plurality of battery cells on an inner wall of the through hole of each of the plurality of battery cells, and the counter electrode conductive member is connected to the counter electrode layer of each of the plurality of battery cells on the inner wall of the through hole of each of the plurality of battery cells.

### BACKGROUND

### 1. Technical Field

The present disclosure relates to a battery, a method for manufacturing a battery, and a circuit board.

### 2. Description of the Related Art

Japanese Unexamined Patent Application Publication No. 2005-235738 discloses a concept of forming through holes in a battery and providing a wiring pattern by using the through holes.

Japanese Unexamined Patent Application Publication No. 2007-207510 discloses a concept of forming through holes in a battery and fastening the battery by using the through holes.

### SUMMARY

The related art faces a demand for improving a capacity density and reliability while enhancing usability when a battery is used by being connected to a circuit. In a case of mounting a battery on a board, for example, there is a demand for improving a capacity density and reliability while enhancing usability by increasing more variations to mount the battery and other devices. Moreover, in this case, it is an important point to reduce a mounting area of the battery in order to increase the capacity density. The reduction in mounting area of the battery is equivalent to reduction in projected area of a power generation element of the battery in plan view of the board, and of each terminal or the like for extracting an electric current from the power generation element of the battery, for example.

One non-limiting and exemplary embodiment provides a battery, a method for manufacturing a battery, and a circuit board, which can achieve a high capacity density and high reliability at the same time.

In one general aspect, the techniques disclosed here feature a battery including: a power generation element including a plurality of battery cells each having an electrode layer, a counter electrode layer, and a solid electrolyte layer located between the electrode layer and the counter electrode layer, the plurality of battery cells being laminated while being electrically connected in parallel; an electrode insulating member; and a counter electrode conductive member, in which each of the plurality of battery cells is provided with a first through hole penetrating in a direction of lamination, the electrode insulating member covers the electrode layer of each of the plurality of battery cells on an inner wall of the first through hole of each of the plurality of battery cells, and the counter electrode conductive member is electrically connected to the counter electrode layer of each of the plurality of battery cells on the inner wall of the first through hole of each of the plurality of battery cells.

According to the battery and the like of the present disclosure, a high capacity density and high reliability can be achieved at the same time.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view of a battery according to Embodiment 1;

FIG. 2 is a top plan view of the battery according to the Embodiment 1;

FIG. 3A is a sectional view of an example of a battery cell included in a power generation element according to the Embodiment 1;

FIG. 3B is a sectional view of another example of the battery cell included in the power generation element according to the Embodiment 1;

FIG. 3C is a sectional view of still another example of the battery cell included in the power generation element according to the Embodiment 1;

FIG. 4 is a sectional view of the power generation element according to the Embodiment 1;

FIG. 5A is a perspective view of a counter electrode conductive member according to the Embodiment 1;

FIG. 5B is a perspective view of a first composite member composed of electrode insulating members and the counter electrode conductive member according to the Embodiment 1;

FIG. 5C is a perspective view of an electrode conductive member according to the Embodiment 1;

FIG. 5D is a perspective view of a second composite member composed of counter electrode insulating members and the electrode conductive member according to the Embodiment 1;

FIG. 6 is a sectional view illustrating a usage example of the battery according to the Embodiment 1;

FIG. 7 is a sectional view of a battery according to Embodiment 2;

FIG. 8 is a sectional view of a battery according to Embodiment 3;

FIG. 9A is a sectional view for explaining a process of forming a first through hole according to the Embodiment 3;

FIG. 9B is a sectional view for explaining a process of forming an electrode insulating member according to the Embodiment 3;

FIG. 10A is a sectional view for explaining a process of forming a second through hole according to the Embodiment 3;

FIG. 10B is a sectional view for explaining a process of forming a counter electrode insulating member according to the Embodiment 3;

FIG. 11 is a sectional view of a battery according to Embodiment 4;

FIG. 12A is a sectional view for explaining a process of forming an electrode insulating member and a counter electrode conductive member according to the Embodiment 4;

FIG. 12B is another sectional view for explaining the process of forming the electrode insulating member and the counter electrode conductive member according to the Embodiment 4;

FIG. 12C is another sectional view for explaining the process of forming the electrode insulating member and the counter electrode conductive member according to the Embodiment 4;

FIG. 12D is another sectional view for explaining the process of forming the electrode insulating member and the counter electrode conductive member according to the Embodiment 4;

FIG. 13 is a sectional view of a battery according to Embodiment 5;

FIG. 14 is a sectional view of a battery according to Embodiment 6;

FIG. 15 is a top plan view of the battery according to the Embodiment 6;

FIG. 16 is a sectional view of a battery according to another example of the Embodiment 6;

FIG. 17 is a sectional view of a circuit board according to Embodiment 7;

FIG. 18 is a flowchart illustrating a first example of a method for manufacturing a battery according to an embodiment;

FIG. 19 is a flowchart illustrating a second example of the method for manufacturing a battery according to the embodiment;

FIG. 20 is a flowchart illustrating a third example of the method for manufacturing a battery according to the embodiment; and

FIG. 21 is a flowchart illustrating a fourth example of the method for manufacturing a battery according to the embodiment.

### DETAILED DESCRIPTIONS

### Summary of Present Disclosure

A battery according to an aspect of the present disclosure includes: a power generation element including a plurality of battery cells each having an electrode layer, a counter electrode layer, and a solid electrolyte layer located between the electrode layer and the counter electrode layer, the plurality of battery cells being laminated while being electrically connected in parallel; an electrode insulating member; and a counter electrode conductive member, in which each of the plurality of battery cells is provided with a first through hole penetrating in a direction of lamination, the electrode insulating member covers the electrode layer of each of the plurality of battery cells on an inner wall of the first through hole of each of the plurality of battery cells, and the counter electrode conductive member is electrically connected to the counter electrode layer of each of the plurality of battery cells on the inner wall of the first through hole of each of the plurality of battery cells.

As such, it is possible to realize a battery that achieves a high capacity density and high reliability at the same time.

To be more precise, the counter electrode conductive member is provided with electrical connection to the respective counter electrode layers of the battery cells inside the first through hole, and has a function to electrically connect the respective battery cells in parallel. Therefore, it is not necessary to form a structure required for the electrical connection of the respective counter electrode layers of the battery cells on the outside of a side surface of the power generation element. Accordingly, the battery can be downsized so that the capacity density of the battery can be increased. It is possible to reduce a mounting area when the battery is mounted on a board, for example.

Meanwhile, the electrode layer is covered with the electrode insulating member on the inner wall of the first through hole. Accordingly, it is possible to suppress a short circuit due to contact between the electrode layer and the counter electrode conductive member and contact between the electrode layer and the counter electrode layer inside the first through hole. Thus, reliability of the battery can be improved.

In the meantime, a structure required for the electrical connection of the respective counter electrode layers of the battery cells does not have to be present on the outside of the side surface of the power generation element. Thus, it is possible to suppress the occurrence of a short circuit associated with a misalignment of the counter electrode conductive member and the like due to an impact from the outside and the like. Thus, it is possible to improve reliability of the battery.

For example, a sectional shape of the first through hole at the electrode layer in a direction perpendicular to the direction of lamination may be different from a sectional shape of the first through hole at the counter electrode layer in the direction perpendicular to the direction of lamination.

As such, it is easier to form the electrode insulating member on the inner wall of the first through hole.

For example, a sectional area of the first through hole at the electrode layer in a direction perpendicular to the direction of lamination may be larger than a sectional area of the first through hole at the counter electrode layer in the direction perpendicular to the direction of lamination.

As such, the first through hole has a structure to spread at a position of the electrode layer. Accordingly, it is possible to provide the insulating member to a portion of the electrode layer at a location where the first through hole spreads, for example. Thus, a structure to cause the electrode insulating member to cover the electrode layer is easily formed. Meanwhile, it is possible to secure a large space for forming the counter electrode conductive member inside the first through hole even when the electrode insulating member covers the electrode layer, so that an increase in resistance of the counter electrode conductive member can be suppressed. As a consequence, it is possible to enhance large current characteristics of the battery.

For example, an inner side surface of the electrode layer may be inclined with respect to the direction of lamination on the inner wall of the first through hole.

As such, the electrode insulating member to cover the electrode layer on the inner wall of the first through hole can be formed by a process such as applying the insulating member in the direction of lamination. Thus, it is possible to form the electrode insulating member easily.

For example, at least a portion of an inner side surface of the counter electrode layer may be parallel to the direction of lamination on the inner wall of the first through hole.

As such, the first through hole does not have a structure in which a space of the first through hole is reduced at a position corresponding to the counter electrode layer, so that an increase in resistance of the counter electrode conductive member can be suppressed at a position to be disposed in the space and connected to the counter electrode layer. As a consequence, it is possible to enhance the large current characteristics of the battery.

For example, the first through hole may include a truncated cone shape.

As such, it is unlikely that corners are formed on the inner wall of the first through hole, so that electric field concentration can be suppressed inside the first through hole.

For example, volumes of the respective first through holes of the plurality of battery cells may be equal.

As such, volumes of the respective battery cells are likely to conform with one another, so that a variation in capacity among the battery cells can be suppressed.

For example, the inner walls of the respective first through holes of the plurality of battery cells may form a continuous surface.

As such, a portion that is prone to breakage is hardly formed on the inner wall and it is less likely to cause collapse of materials of the battery cells on the inner wall.

For example, the first through holes of at least a portion of battery cells among the plurality of battery cells may be concatenated.

As such, it is easier to form the electrode insulating member and the counter electrode conductive member inside the first through hole.

For example, in the power generation element, a portion of the plurality of battery cells may constitute a first cell laminated body by being laminated in such a way as to concatenate the first through holes, another portion of the plurality of battery cells may constitute a second cell laminated body by being laminated in such a way as to concatenate the first through holes, and a position of the first through holes in the first cell laminated body may be different from a position of the first through holes in the second cell laminated body when viewed in the direction of lamination.

As such, even when the number of the laminated battery cells is increased and a problem is likely to occur as a consequence of forming the first through holes at the same position of all of the battery cells, the first through holes can be formed while changing the positions thereof. For example, it is possible to avoid a situation where formation of the electrode insulating member and the counter electrode conductive member inside the first through holes is complicated by the increase in number of the battery cells.

For example, each of the plurality of battery cells may be provided with a second through hole penetrating in the direction of lamination, and the battery may further include a counter electrode insulating member that covers the counter electrode layer of each of the plurality of battery cells on an inner wall of the second through hole of each of the plurality of battery cells, and an electrode conductive member that is electrically connected to the electrode layer of each of the plurality of battery cells on the inner wall of the second through hole of each of the plurality of battery cells.

As such, it is possible to realize the battery that achieves a high capacity density and high reliability at the same time.

To be more precise, the electrode conductive member is provided with electrical connection to the respective electrode layers of the battery cells inside the second through hole, and has a function to electrically connect the respective battery cells in parallel. Therefore, it is not necessary to form a structure required for the electrical connection of the respective electrode layers of the battery cells on the outside of the side surface of the power generation element. Accordingly, the battery can be downsized so that the capacity density of the battery can be increased. It is possible to reduce the mounting area when the battery is mounted on the board, for example.

Meanwhile, the counter electrode layer is covered with the counter electrode insulating member on the inner wall of the second through hole. Accordingly, it is possible to suppress a short circuit due to contact between the counter electrode layer and the electrode conductive member and contact between the electrode layer and the counter electrode and the counter electrode layer inside the second through hole. Thus, reliability of the battery can be improved.

In the meantime, a structure required for the electrical connection of the respective electrode layers of the battery cells does not have to be present on the outside of the side surface of the power generation element. Thus, it is possible to suppress the occurrence of a short circuit associated with a misalignment of the electrode conductive member and the like due to an impact from the outside and the like. Thus, it is possible to improve reliability of the battery.

A method for manufacturing a battery according to another aspect of the present disclosure includes: forming a laminated body by sequentially laminating a plurality of battery cells each including an electrode layer, a counter electrode layer, and a solid electrolyte layer located between the electrode layer and the counter electrode layer, in such a way that orders of arrangement of the electrode layer, the counter electrode layer, and the solid electrolyte layer included in each of the plurality of battery cells are alternately reversed; forming a through hole in each of the plurality of battery cells in such a way as to penetrate in a direction of lamination; forming an electrode insulating member on an inner wall of the through hole formed in each of the plurality of battery cells in such a way as to cover the electrode layer of each of the plurality of battery cells; and forming a counter electrode conductive member on the inner wall of the through hole formed in each of the plurality of battery cells in such a way as to be electrically connected to the counter electrode layer of each of the plurality of battery cells.

As such, it is possible to manufacture the battery that achieves the high capacity density and high reliability at the same time as mentioned above.

For example, the forming a through hole may be carried out after the forming a laminated body.

As such, the through holes can be formed in the laminated battery cells in a lump, respectively. Thus, productivity of the battery is improved.

For example, in the forming a laminated body, the plurality of battery cells may be laminated after the forming a through hole in such a way as to concatenate the through holes formed in the plurality of battery cells, respectively, and the method for manufacturing a battery may carry out the forming an electrode insulating member and the forming a counter electrode conductive member after the forming a laminated body.

As such, the through hole can be formed in each of the battery cells, so that freedom of the shapes of the through holes is increased. Moreover, the counter electrode conductive member and the electrode insulating members can be formed in the through holes of the laminated battery cells in a lump. Thus, productivity of the battery is improved.

For example, in the forming a through hole, the through hole may be formed such that a sectional area of the through hole at the electrode layer in a direction perpendicular to the direction of lamination is larger than a sectional area of the through hole at the counter electrode layer in the direction perpendicular to the direction of lamination, in the forming an electrode insulating member, the through hole formed in each of the plurality of battery cells may be filled with an insulating member, and a columnar hole extending in a direction of concatenation of the through holes and having a sectional area smaller than the sectional area of the through hole at the electrode layer in the direction perpendicular to the direction of lamination and larger than the sectional area of the through hole at the counter electrode layer in the direction perpendicular to the direction of lamination is formed in a region including the filled insulating member, so as to form the electrode insulating member by using a remaining portion of the insulating member and to expose the counter electrode layer of each of the plurality of battery cells, and in the forming a counter electrode conductive member, the counter electrode conductive member may be formed by filling the columnar hole with a conductive material.

As such, the electrode insulating members and the counter electrode conductive member can be formed in a lump in the respective through holes of the battery cells by using the shapes of the through holes. Thus, productivity can be improved.

For example, the method for manufacturing a battery may carry out the forming a through hole, the forming an electrode insulating member, and the forming a counter electrode conductive member before the forming a laminated body.

As such, the electrode insulating members and the counter electrode conductive member can be formed in the respective through holes of the battery cells, so that the electrode insulating members and the counter electrode conductive member can be formed easily and accurately.

For example, the method for manufacturing a battery may carry out the forming a through hole and the forming an electrode insulating member before the forming a laminated body, and may carry out the forming a counter electrode conductive member after the forming a laminated body.

As such, the electrode insulating members that are required to be formed accurately in order to improve reliability of the battery can be formed easily and accurately. Moreover, the counter electrode conductive member can be formed in a lump in the through holes of the laminated battery cells. Thus, productivity of the battery can be improved.

A circuit board according to still another aspect of the present disclosure includes: a power generation element including a plurality of battery cells each having an electrode layer, a counter electrode layer, and a solid electrolyte layer located between the electrode layer and the counter electrode layer, the plurality of battery cells being laminated while being electrically connected in parallel; an electrode insulating member; a counter electrode conductive member; and a circuit pattern layer being laminated on the power generation element and including circuit wiring, in which each of the plurality of battery cells is provided with a first through hole penetrating in a direction of lamination, the electrode insulating member covers the electrode layer of each of the plurality of battery cells on an inner wall of the first through hole of each of the plurality of battery cells, and the counter electrode conductive member is electrically connected to the counter electrode layer of each of the plurality of battery cells on the inner wall of the first through hole of each of the plurality of battery cells, and is electrically connected to a portion of the circuit wiring.

As such, the circuit board including the above-mentioned battery that achieves the high capacity density and high reliability at the same time and the circuit pattern layer connected to the battery is realized. Moreover, since the wiring board and the battery are integrated together, downsizing and thin profiling of electronic equipment can be realized. Meanwhile, electric power can be directly supplied from the power generation element to a required location on the circuit wiring. Thus, it is possible to reduce extension of the wiring and to suppress radiation noise from the wiring.

For example, each of the plurality of battery cells may be provided with a second through hole penetrating in the direction of lamination, and the circuit board may further include a counter electrode insulating member that covers the counter electrode layer of each of the plurality of battery cells on an inner wall of the second through hole of each of the plurality of battery cells, and an electrode conductive member that is electrically connected to the electrode layer of each of the plurality of battery cells on the inner wall of the second through hole of each of the plurality of battery cells, and is electrically connected to another portion of the circuit wiring.

As such, the counter electrode conductive member and the electrode conductive member provided inside the first through hole and the second through hole are connected to the circuit wiring on the circuit pattern layer that is laminated on the power generation element. Thus, it is possible to shorten connection distances from a positive electrode and a negative electrode of the power generation element to the circuit wiring.

Embodiments will be specifically described below with reference to the drawings.

Note that each embodiment described below represents a comprehensive or specific example. Numerical values, shapes, materials, constituents, layout positions and modes of connection of the constituents, steps, the order of the steps, and the like depicted in the following embodiments are examples and are not intended to restrict the present disclosure. Meanwhile, of the constituents in the following embodiments, a constituent not defined in an independent claim will be described as an optional constituent.

In the meantime, the respective drawings are schematic diagrams and are not always illustrated precisely. Accordingly, scales and other factors do not always coincide with one another in the respective drawings, for example. Moreover, in the respective drawings, the structures which are substantially the same are denoted by the same reference signs and overlapping explanations thereof may be omitted or simplified.

Meanwhile, in the present specification, terms that represent relations between elements such as parallelism and orthogonality, terms that represent shapes of the elements such as a rectangle and a rectangular parallelepiped, and numerical ranges are not expressions that only represent precise meanings but are rather expressions that encompass substantially equivalent ranges with allowances of several percent, for example.

In the meantime, in the present specification and the drawings, x axis, y axis, and z axis represent three axes of a three-dimensional orthogonal coordinate system. In a case where a shape in plan view of a power generation element of a battery is a rectangle, the x axis and the y axis coincide with directions parallel to a first side of the rectangle and to a second side being orthogonal to the first side, respectively. The z axis coincides with a direction of lamination of battery cells included in the power generation element and of respective layers of each battery cell.

Meanwhile, in the present specification, a “direction of lamination” coincides with a direction of a normal line to principal surfaces of current collectors and active material layers. Moreover, in the present specification, a “plan view” means a view in a direction perpendicular to a principal surface of the power generation element unless otherwise specifically stated such as a case where the term is used alone. Here, in a case of description of a “plan view of a certain surface” such as a “plan view of a side surface”, the term means a view from the front of the “certain surface”.

In the meantime, in the present specification, terms “above” and “below” do not represent an upward direction (vertically upward) and a downward direction (vertically downward) in light of absolute spatial recognition, but are used as terms to be defined depending on a relative positional relationship based on the order of lamination in a laminated structure. Moreover, the terms “above” and “below” are used not only in a case where two constituents are disposed with an interval therebetween and another constituent is present between these two constituents, but also in a case where two constituents are disposed close to each other and the two constituents are in contact with each other. In the following description, a negative side of the z axis will be referred to as “below” or a “lower side” while a positive side of the z axis will be referred to as “above” or an “upper side”.

Meanwhile, in the present specification, an expression “to cover A” means to cover at least a portion of “A”. Specifically, the expression “to cover A” is the expression encompassing not only a case of “covering all of A” but also a case of “covering only a portion of A”. Here, “A” is a side surface, a principal surface, and the like of a layer or a certain member such as a terminal.

In the meantime, in the present specification, ordinal numbers such as “first” and “second” are not intended to represent the number or the order of the constituents but are used for the purpose of distinguishing the constituents while avoiding confusion of the constituents of the same type unless otherwise specifically stated.

### Embodiment 1

A configuration of a battery according to Embodiment 1 will be described below.

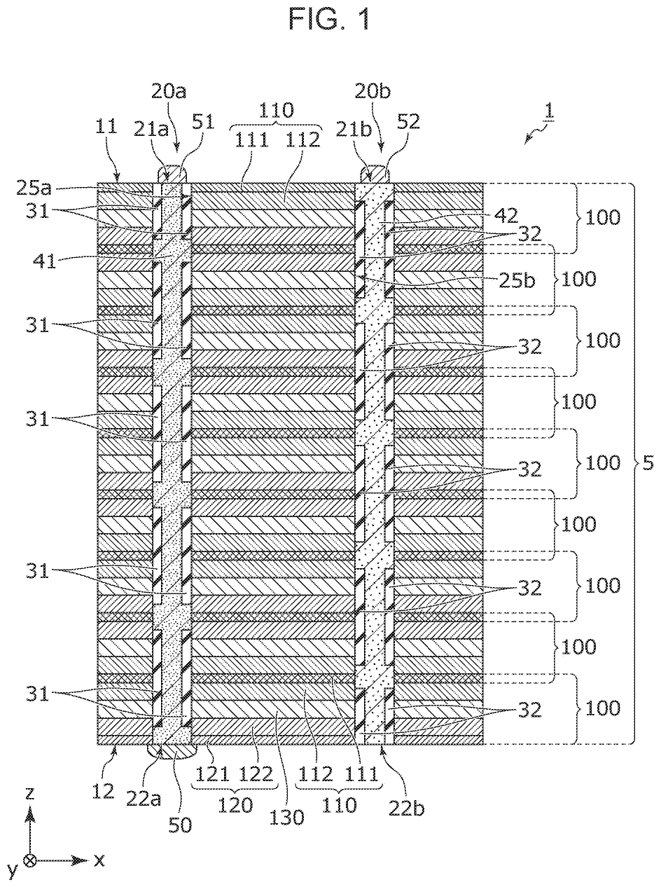

FIG. 1 is a sectional view of a battery 1 according to the present embodiment. As illustrated in FIG. 1, the battery 1 includes a power generation element 5, an electrode insulating member 31, a counter electrode insulating member 32, a counter electrode conductive member 41, an electrode conductive member 42, a connecting member 50, a counter electrode current collecting terminal 51, and an electrode current collecting terminal 52. The battery 1 is an all-solid-state battery, for example.

### 1. Power Generation Element

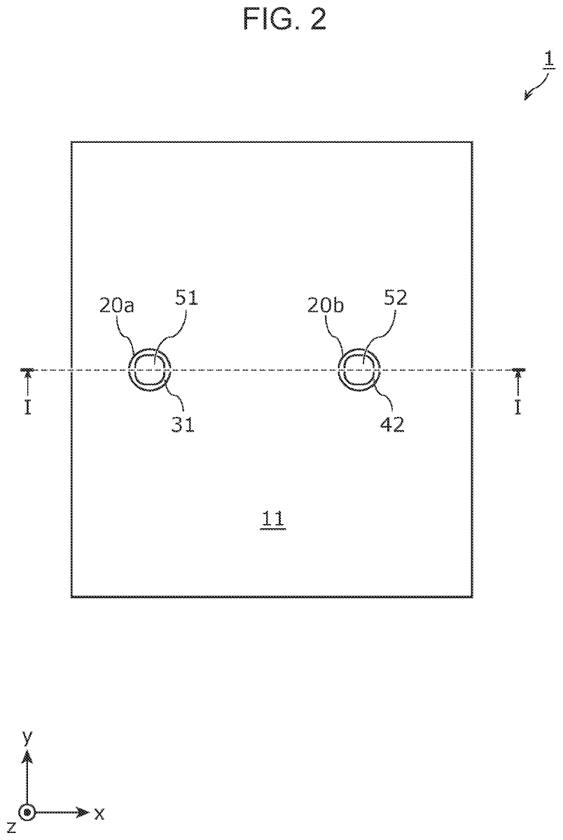

First, a specific configuration of the power generation element 5 will be described with reference to FIGS. 1 and 2. FIG. 2 is a top plan view of the battery 1 according to the present embodiment. Here, FIG. 1 illustrates a section taken along the I-I line in FIG. 2.

As illustrated in FIG. 2, a shape in plan view of the power generation element 5 is a rectangle, for example. In other words, the shape of the power generation element 5 is a flat rectangular parallelepiped. Here, flatness means that a thickness (namely, a length in z-axis direction) is shorter than respective sides (namely, respective lengths in x-axis direction and y-axis direction) or a maximum width of a principal surface. The shape in plan view of the power generation element 5 may be any of other polygons including a square, a hexagon, and an octagon, or may be any of a circle, an ellipse, and the like. It is to be noted that a thickness of each of layers is illustrated in an exaggerated manner in the sectional views such as FIG. 1 in order to clarify a layered structure of the power generation element 5.

As illustrated in FIGS. 1 and 2, the power generation element 5 includes a principal surface 11 and a principal surface 12 as two principal surfaces thereof. In the present embodiment, each of the principal surface 11 and the principal surface 12 is a flat surface.

The principal surface 11 and the principal surface 12 are back to back to each other and are parallel to each other. The principal surface 11 is the uppermost surface of the power generation element 5. The principal surface 12 is a surface on an opposite side to the principal surface 11 and is the lowermost surface of the power generation element 5. Each of the principal surface 11 and the principal surface 12 has a larger area than that of a side surface of the power generation element 5, for example.

Side surfaces of the power generation element 5 include two sets of two side surfaces being back to back to each other and parallel to each other. Each side surface of the power generation element 5 is a flat surface, for example. Each side surface of the power generation element 5 is a cut surface formed by cutting a laminated body of battery cells 100 in a lump, for example. The battery cells 100 having the same size can be formed by aligning a cutting direction with a direction of lamination.

As illustrated in FIG. 1, the power generation element 5 includes the battery cells 100. Each battery cell 100 is a battery of a minimum structure and is also referred to as a unit cell. The battery cells 100 are laminated while being electrically connected in parallel. In the present embodiment, all of the battery cells 100 included in the power generation element 5 are electrically connected in parallel. The battery 1 is a laminated battery formed by integrating the battery cells 100 by means of adhesion, bonding, or the like. Although the number of the battery cells 100 included in the power generation element 5 is nine cells in the example illustrated in FIG. 1, the number of the battery cells is not limited to the foregoing. For example, the number of the battery cells 100 included in the power generation element 5 may be even cells such as two cells and four cells, or odd cells such as three cells and five cells.

Each of the battery cells 100 is provided with a through hole 20a and a through hole 20b which penetrate each battery cell 100 in the direction of lamination. The respective through holes 20a and the respective through holes 20b of the battery cells 100 are formed in a lump by drilling holes that penetrate the power generation element 5 in the direction of lamination, for example. The through hole 20a is an example of a first through hole. The through hole 20b is an example of a second through hole.

Each of the battery cells 100 includes an electrode layer 110, a counter electrode layer 120, and a solid electrolyte layer 130. The electrode layer 110 includes an electrode current collector 111 and an electrode active material layer 112. The counter electrode layer 120 includes a counter electrode current collector 121 and a counter electrode active material layer 122. In each of the battery cells 100, the electrode current collector 111, the electrode active material layer 112, the solid electrolyte layer 130, the counter electrode active material layer 122, and the counter electrode current collector 121 are laminated in this order along the z axis. In each battery cell 100, the electrode current collector 111, the electrode active material layer 112, the solid electrolyte layer 130, the counter electrode active material layer 122, and the counter electrode current collector 121 extend in a direction perpendicular to the z-axis direction (namely, in the x-axis direction and the y-axis direction), respectively.

Here, the electrode layer 110 is one of a positive electrode layer and a negative electrode layer of the battery cell 100. The counter electrode layer 120 is the other one of the positive electrode layer and the negative electrode layer of the battery cell 100. In the following, a description will be given of a case where the electrode layer 110 is the positive electrode layer and the counter electrode layer 120 is the negative electrode layer as an example.

Configurations of the battery cells 100 are substantially the same as one another. Regarding two battery cells 100 located adjacent to each other, the orders of arrangement of the respective layers constituting the battery cells 100 are reverse to each other. That is to say, the battery cells 100 are laminated along the z axis while alternately reversing the orders of arrangement of the respective layers constituting the battery cells 100. In the present embodiment, the number of the battery cells 100 is an odd number. As a consequence, the lowermost layer and the uppermost layer of the power generation element 5 are current collectors having different polarities from each other.

The battery cells 100 have the same size as one another, for example. This makes it easier to conform states of operation among the battery cells 100 so that the battery 1 achieving a high capacity density and high reliability at the same time can be realized.

In the present embodiment, the principal surface 11 constitutes a portion of the electrode layer 110 of the battery cell 100 located uppermost. To be more precise, the principal surface 11 is a principal surface on the upper side of the electrode layer 110 of the battery cell 100 located uppermost.

Meanwhile, the principal surface 12 constitutes a portion of the counter electrode layer 120 of the battery cell 100 located lowermost. To be more precise, the principal surface 12 is a principal surface on the lower side of the counter electrode layer 120 of the battery cell 100 located lowermost.

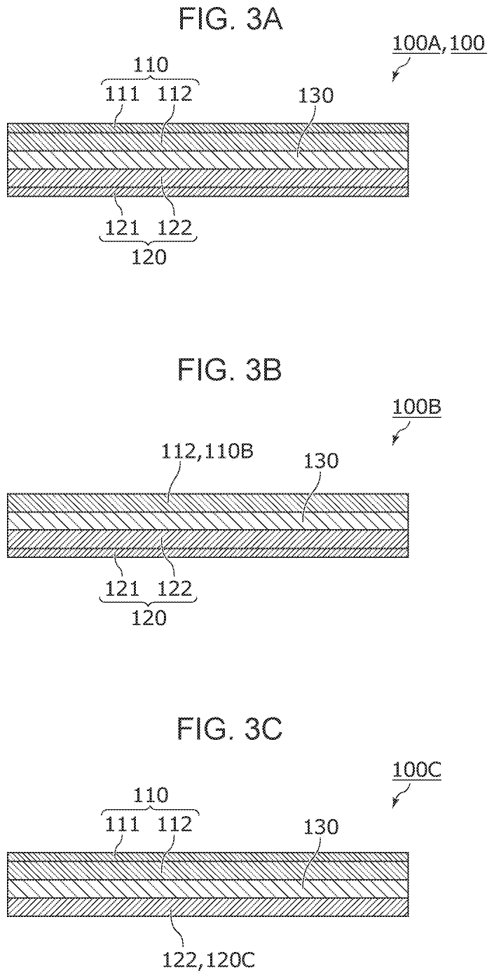

A description will be given below of the respective layers of the battery cell 100 with reference to FIG. 3A. FIG. 3A is a sectional view of the battery cell 100 included in the power generation element 5 according to the present embodiment.

Each of the electrode current collector 111 and the counter electrode current collector 121 is a conductive member in any of a foil form, a plate form, and a mesh form. Each of the electrode current collector 111 and the counter electrode current collector 121 may be a conductive thin film, for example. Examples of a material usable for constituting the electrode current collector 111 and the counter electrode current collector 121 include metals such as stainless steel (SUS), aluminum (Al), copper (Cu), and nickel (Ni). The electrode current collector 111 and the counter electrode current collector 121 may be formed by using different materials from each other.

A thickness of each of the electrode current collector 111 and the counter electrode current collector 121 is greater than or equal to 5 m and less than or equal to 100 m, for example. However, the thickness is not limited to this range. The electrode active material layer 112 is in contact with the principal surface of the electrode current collector 111. Here, the electrode current collector 111 may include a current collector layer which is a layer being provided at a portion in contact with the electrode active material layer 112 and containing a conductive material. The counter electrode active material layer 122 is in contact with the principal surface of the counter electrode current collector 121. Here, the counter electrode current collector 121 may include a current collector layer which is a layer being provided at a portion in contact with the counter electrode active material layer 122 and containing a conductive material.

The electrode active material layer 112 is disposed at the principal surface on the counter electrode layer 120 side of the electrode current collector 111. The electrode active material layer 112 is a layer including a positive electrode material such as an active material. The electrode active material layer 112 contains a positive electrode active material, for example.

A positive electrode active material such as lithium cobaltate composite oxide (LCO), lithium nickelate composite oxide (LNO), lithium manganate composite oxide (LMO), lithium-manganese-nickel composite oxide (LMNO), lithium-manganese-cobalt composite oxide (LMCO), lithium-nickel-cobalt composite oxide (LNCO), and lithium-nickel-manganese-cobalt composite oxide (LNMCO) can be used as the positive electrode active material contained in the electrode active material layer 112, for example. Various materials that can extract and insert ions such as Li and Mg can be used as the material of the positive electrode active material.

Meanwhile, a solid electrolyte such as an inorganic solid electrolyte may be used as a material contained in the electrode active material layer 112, for example. A sulfide solid electrolyte, an oxide solid electrode, and the like can be used as the inorganic solid electrolyte. A mixture of Li₂S and P₂S₅ can be used as the sulfide solid electrolyte, for example. A surface of the positive electrode active material may be coated with a solid electrolyte. In the meantime, a conducting agent such as acetylene black or a binder such as polyvinylidene fluoride may be used as the material contained in the electrode active material layer 112.

The electrode active material layer 112 is fabricated by applying a coating material in the form of a paste, which is prepared by kneading the materials contained in the electrode active material layer 112 together with a solvent, onto the principal surface of the electrode current collector 111 and drying the coating material. In order to increase a density of the electrode active material layer 112, the electrode layer 110 including the electrode active material layer 112 and the electrode current collector 111 (also referred to as an electrode plate) may be pressed after a drying process. A thickness of the electrode active material layer 112 is greater than or equal to 5 m and less than or equal to 300 m, for example. However, the thickness is not limited to this range.

The counter electrode active material layer 122 is disposed on the principal surface on the electrode layer 110 side of the counter electrode current collector 121. The counter electrode active material layer 122 is disposed opposite to the electrode active material layer 112. The counter electrode active material layer 122 is a layer including a negative electrode material such as an active material. The negative electrode material is a material constituting a counter electrode to the positive electrode material. The counter electrode active material layer 122 contains a negative electrode active material, for example.

A negative electrode active material such as graphite and metallic lithium can be used as the negative electrode active material to be contained in the counter electrode active material layer 122, for example. Various materials that can extract and insert ions as typified by lithium (Li) and magnesium (Mg) can be used as the material of the negative electrode active material.

Meanwhile, a solid electrolyte such as an inorganic solid electrolyte may be used as a material contained in the counter electrode active material layer 122, for example. A sulfide solid electrolyte, an oxide solid electrode, and the like can be used as the inorganic solid electrolyte, for example. A mixture of lithium sulfide (Li₂S) and phosphorus pentasulfide (P₂S₅) can be used as the sulfide solid electrolyte, for example. In the meantime, a conducting agent such as acetylene black or a binder such as polyvinylidene fluoride may be used as the material contained in the counter electrode active material layer 122.

The counter electrode active material layer 122 is fabricated by applying a coating material in the form of a paste, which is prepared by kneading the materials contained in the counter electrode active material layer 122 together with a solvent, onto the principal surface of the counter electrode current collector 121 and drying the coating material. In order to increase a density of the counter electrode active material layer 122, the counter electrode layer 120 including the counter electrode active material layer 122 and the counter electrode current collector 121 (also referred to as a counter electrode plate) may be pressed after a drying process. A thickness of the counter electrode active material layer 122 is greater than or equal to 5 m and less than or equal to 300 m, for example. However, the thickness is not limited to this range.

The solid electrolyte layer 130 is disposed between the electrode active material layer 112 and the counter electrode active material layer 122. The solid electrolyte layer 130 is in contact with the electrode active material layer 112 and with the counter electrode active material layer 122, respectively. The solid electrolyte layer 130 is a layer including an electrolyte material. Publicly known electrolytes designed for batteries can be used as such an electrolyte material. A thickness of the solid electrolyte layer 130 may be greater than or equal to 5 m and less than or equal to 300 m, or may be greater than or equal to 5 m and less than or equal to 100 m.

The solid electrolyte layer 130 contains a solid electrolyte. The solid electrolyte has lithium-ion conductivity, for example. A sulfide solid electrolyte, an oxide solid electrode, and the like can be used as the inorganic solid electrolyte. A mixture of Li₂S and P₂S₅ can be used as the sulfide solid electrolyte, for example. Here, the solid electrolyte layer 130 may contain a binder such as polyvinylidene fluoride in addition to the electrolyte material.

In the present embodiment, the electrode active material layer 112, the counter electrode active material layer 122, and the solid electrolyte layer 130 are maintained in a state of parallel flat plates. In this way, it is possible to suppress the occurrence of cracks or collapse due to flexure. Here, the electrode active material layer 112, the counter electrode active material layer 122, and the solid electrolyte layer 130 may be integrated and gently curved together.

Meanwhile, in the present embodiment, an end surface of the electrode current collector 111 and an end surface of the counter electrode current collector 121 coincide with each other when viewed in the z-axis direction.

To be more precise, in the battery cell 100, respective shapes and sizes of the electrode current collector 111, the electrode active material layer 112, the solid electrolyte layer 130, the counter electrode active material layer 122, and the counter electrode current collector 121 are the same and contours of the respective layers coincide with one another.

In other words, the shape of the battery cell 100 is a flat plate shape in the form of a flat rectangular parallelepiped.

As illustrated in FIG. 1, in the present embodiment, a current collector is shared by two battery cells 100 located adjacent to each other. For example, the battery cell 100 at the lowermost layer and the battery cell 100 located immediately thereabove share one electrode current collector 111.

To be more precise, as illustrated in FIG. 1, the two electrode layers 110 located adjacent to each other in the battery cells 100 mutually share the electrode current collector 111. The electrode active material layers 112 are provided on both principal surfaces of the shared electrode current collector 111. Meanwhile, the two counter electrode layers 120 located adjacent to each other mutually share the counter electrode current collector 121. The counter electrode active material layers 122 are provided on both principal surfaces of the shared counter electrode current collector 121.

The above-described battery 1 is formed by laminating not only the battery cells 100 illustrated in FIG. 3A but also battery cells 100B and 100C illustrated in FIGS. 3B and 3C in combination. Note that the battery cell 100 illustrated in FIG. 3A will be explained herein as a battery cell 100A.

The battery cell 100B illustrated in FIG. 3B has a configuration to exclude the electrode current collector 111 from the battery cell 100A illustrated in FIG. 3A. That is to say, an electrode layer 110B of the battery cell 100B consists of the electrode active material layer 112.

The battery cell 100C illustrated in FIG. 3C has a configuration to exclude the counter electrode current collector 121 from the battery cell 100A illustrated in FIG. 3A. That is to say, a counter electrode layer 120C of the battery cell 100C consists of the counter electrode active material layer 122.

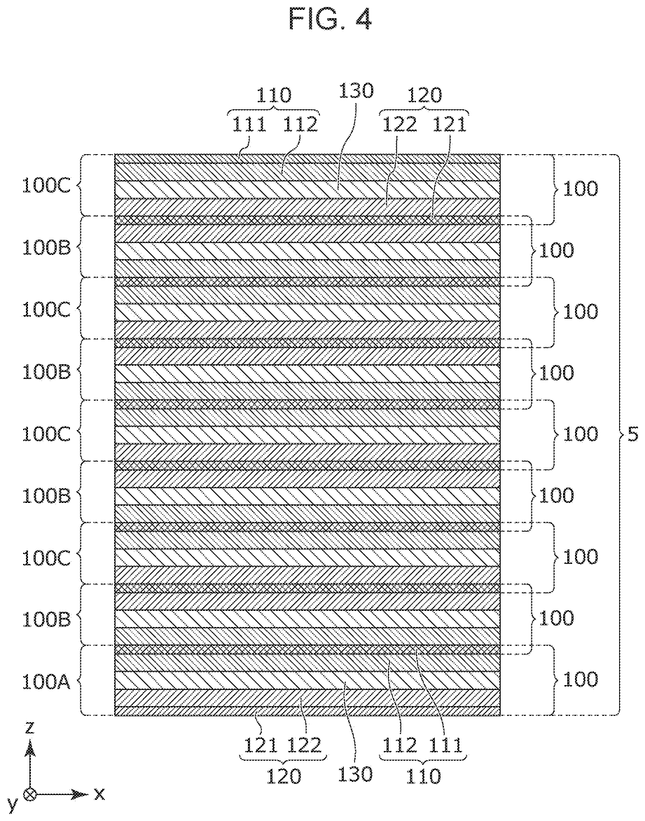

FIG. 4 is a sectional view illustrating the power generation element 5 according to the present embodiment. FIG. 4 is a view extracting only the power generation element 5 in FIG. 1 and illustrating a state before formation of the through holes 20a and the through holes 20b in the battery cells 100. As illustrated in FIG. 4, the battery cell 100A is disposed at the lowermost layer and the battery cells 100B and 100C are alternately laminated upward. In this instance, each battery cell 100B is laminated while vertically reversing the orientation illustrated in FIG. 3B. The power generation element 5 is formed in this way.

Note that the method of forming the power generation element 5 is not limited to this method. For example, the battery cells 100A may be disposed at the uppermost layer. On the other hand, the battery cell 100A may be disposed at a position different from both the uppermost layer and the lowermost layer, for example. In the meantime, two or more battery cells 100A may be used instead. Otherwise, a unit of two battery cells 100 sharing a current collector may be formed by subjecting a single current collector to double-sided coating, and the units thus formed may be laminated.

As described above, in the power generation element 5 according to the present embodiment, all of the battery cells 100 are connected in parallel and no batteries connected in series are included therein. Accordingly, it is less likely to cause unevenness in states of charge and discharge of the battery 1 attributed to a variation in capacity of the battery cells 100 and so forth. As a consequence, it is possible to considerably reduce a possibility of overcharge or overdischarge of a portion of the battery cells 100, and to improve reliability of the battery 1.

### 2. Through Holes

Next, the through hole 20a and the through hole 20b will be described with reference to FIGS. 1 and 2 again.

The through hole 20a and the through hole 20b are provided to each of the battery cells 100. The through hole 20a and the through hole 20b are not connected to each other and are independent of each other. In the present embodiment, the through hole 20a and the through hole 20b have the same size and the same shape.

In each of the battery cells 100, each of the through hole 20a and the through hole 20b penetrates from one principal surface of the battery cell 100 to another principal surface thereof. Each of the through hole 20a and the through hole 20b originates from the one principal surface of the battery cell 100, passes through the electrode layer 110, the solid electrolyte layer 130, and the counter electrode layer 120, and reaches the other principal surface of the battery cell 100.

A width (lengths in the x-axis direction and the y-axis direction) of each of the through holes 20a of the battery cells 100 is constant. That is to say, regarding the respective through holes 20a of the battery cells 100, sectional areas of the through holes 20a at any positions in a direction perpendicular to the direction of lamination are constant. A width (lengths in the x-axis direction and the y-axis direction) of each of the through holes 20b of the battery cells 100 is constant. That is to say, regarding the respective through holes 20b of the battery cells 100, sectional areas of the through holes 20b at any positions in the direction perpendicular to the direction of lamination are constant.

The respective through holes 20a of the battery cells 100 and the respective through holes 20b of the battery cells 100 are concatenated with one another, respectively. Accordingly, the respective through hole 20a of the battery cells 100 and the respective through holes 20b of the battery cells 100 each form a single through hole that penetrates the power generation element 5 in the direction of lamination. In this way, it is easier to form conductive members and the like to be disposed inside the through holes 20a and inside the through holes 20b.

Meanwhile, each of the through holes 20a of the battery cells 100 and each of the through holes 20b of the battery cells 100 has a columnar shape, for example. The shape of each of the through holes 20a and the through holes 20b is not limited to the columnar shape but may be any other shapes including a polygonal prism shape such as a quadrangular prism shape and a hexagonal prism shape.

In the meantime, the respective through holes 20a of the battery cells 100 have substantially the same volume and the same shape. Accordingly, in the respective through holes 20a of the battery cells 100, the sectional areas of the through holes 20a in the direction perpendicular to the direction of lamination are substantially equal. The respective through holes 20b of the battery cells 100 have substantially the same volume and the same shape. Accordingly, in the respective through holes 20b of the battery cells 100, the sectional areas of the through holes 20b in the direction perpendicular to the direction of lamination are substantially equal. Even when each of the battery cells 100 is provided with the through hole 20a and the through hole 20b, the volumes of the battery cells 100 are likely to conform with one another since the volumes of the through hole 20a and the through hole 20b are equal, so that a variation in capacity among the battery cells 100 can be suppressed. For this reason, it is easier to equalize operating voltages for the battery cells 100 that are laminated while being connected in parallel in the course of charge and discharge of the battery 1, and the occurrence of overcharge or overdischarge of a certain battery cell 100 is suppressed. Thus, reliability of the battery 1 can be improved.

The inner walls 25a of the respective through holes 20a of the battery cells 100 form one continuous surface. Accordingly, the respective through holes 20a of the battery cells 100 are concatenated in such a way as to penetrate the power generation element 5 in the direction of lamination, thereby forming a single elongate through hole of a columnar shape. Since the inner walls 25a of the respective through holes 20a of the battery cells 100 are concatenated as described above, a portion that is prone to breakage is hardly formed on the inner walls 25a and it is less likely to cause collapse of the materials of the battery cells 100 on the inner walls 25a and the like. Meanwhile, materials are easily inserted into the through holes 20a in the course of forming the electrode insulating member 31 and the counter electrode conductive member 41. Here, a direction of concatenation of the respective through holes 20a of the battery cells 100 may be inclined with respect to the direction of lamination.

The inner walls 25b of the respective through holes 20b of the battery cells 100 form one continuous surface. Accordingly, the respective through holes 20b of the battery cells 100 are concatenated in such a way as to penetrate the power generation element 5 in the direction of lamination, thereby forming a single elongate through hole of a columnar shape. Here, a direction of concatenation of the respective through holes 20b of the battery cells 100 may be inclined with respect to the direction of lamination.

In the power generation element 5, the through hole 20a and the through hole 20b of the battery cell 100 located uppermost are open on the principal surface 11. That is to say, an opening position 21a of the through hole 20a and an opening position 21b of the through hole 20b of the battery cell 100 located uppermost are located at the principal surface 11.

Meanwhile, in the power generation element 5, the through hole 20a and the through hole 20b of the battery cell 100 located lowermost are open on the principal surface 12. That is to say, an opening position 22a of the through hole 20a and an opening position 22b of the through hole 20b of the battery cell 100 located lowermost are located at the principal surface 12.

The inner walls 25a of the respective through holes 20a of the battery cells 100 and the inner walls 25b of the respective through holes 20b of the battery cells 100 are parallel to the direction of lamination, respectively. Each inner wall 25a is an inner side surface of the battery cell 100 constituting the through hole 20a. Each inner wall 25b is an inner side surface of the battery cell 100 constituting the through hole 20b. Each of the inner wall 25a and the inner wall 25b is formed from inner side surfaces of the electrode layer 110, the solid electrolyte layer 130, and the counter electrode layer 120, for example.

The through hole 20a and the through hole 20b are arranged in the x-axis direction in plan view, for example. A positional relationship between the through hole 20a and the through hole 20b in plan view is not limited to a particular relationship, and is designed depending on a wiring pattern and the like on a board on which the battery 1 is mounted, for example.

### 3. Insulating Members

Next, the electrode insulating members 31 and the counter electrode insulating members 32 will be described.

As illustrated in FIG. 1, the electrode insulating members 31 are disposed inside the through holes 20a. The electrode insulating members 31 cover the electrode layers 110 at the inner walls 25a of the respective through holes 20a of the battery cells 100. To be more precise, the electrode insulating members 31 completely cover the electrode current collectors 111 and the electrode active material layers 112 at the inner walls 25a of the respective through holes 20a of the battery cells 100. A clearance may be provided at a portion between the electrode insulating members 31 and the inner walls 25a.

The electrode insulating members 31 cover the respective electrode layers 110 of the battery cells 100 at the inner walls 25a of the respective through holes 20a of the battery cells 100. The electrode insulating members 31 do not cover at least a portion of each of the counter electrode layers 120 of the battery cells 100. The electrode insulating members 31 do not cover the counter electrode current collectors 121, for example. Each electrode insulating member 31 is formed for every two battery cells 100 located adjacent to each other, for instance. A shape of the electrode insulating member 31 is a tubular shape having a circular or polygonal circumference, for example. Note that the shape of the electrode insulating member 31 is not limited to the aforementioned shape. The electrode insulating member 31 is formed in conformity to the shapes of the through hole 20a and the counter electrode conductive member 41, for example.

Each electrode insulating member 31 continuously covers the electrode layers 110 of the two battery cells 100 located adjacent to each other. To be more precise, the electrode insulating member 31 is provided for every two battery cells 100 located adjacent to each other except the battery cell 100 located uppermost and continuously covers from at least a portion of the counter electrode active material layer 122 of one battery cell 100 out of the two battery cells 100 located adjacent to each other, the solid electrolyte layer 130 thereof, the electrode active material layer 112 thereof, the shared electrode current collector 111, the electrode active material layer 112 of the other battery cell 100, the solid electrolyte layer 130 thereof, and at least a portion of the counter electrode active material layer 122 thereof. As described above, since the electrode insulating member 31 covers the solid electrolyte layer 130 and the counter electrode active material layer 122 in addition to the electrode layer 110, it is less likely to expose the electrode layer 110 to the inner wall 25a even in case of a variation in width (the length in the z-axis direction) due to production tolerance of the electrode insulating member 31. Accordingly, it is less likely that the electrode layer 110 comes into contact with the counter electrode conductive member 41 on the inner wall 25a to cause a short circuit, so that reliability of the battery 1 can be improved. Note that the electrode insulating member 31 does not always have to cover the counter electrode active material layers 122. Meanwhile, the electrode insulating member 31 does not always have to cover the solid electrolyte layer 130, either.

As illustrated in FIG. 1, the counter electrode insulating members 32 are disposed inside the through holes 20b. The counter electrode insulating members 32 cover the counter electrode layers 120 at the inner walls 25b of the through holes 20b. To be more precise, the counter electrode insulating members 32 completely cover the counter electrode current collectors 121 and the counter electrode active material layers 122 at the inner walls 25b of the through holes 20b. A clearance may be provided at a portion between the counter electrode insulating members 32 and the inner walls 25b.

The counter electrode insulating members 32 cover the respective counter electrode layers 120 of the battery cells 100 at the inner walls 25b of the respective through holes 20b of the battery cells 100. The counter electrode insulating members 32 do not cover at least a portion of each of the electrode layers 110 of the battery cells 100. The counter electrode insulating members 32 do not cover the electrode current collectors 111, for example. Each counter electrode insulating member 32 is formed for every two battery cells 100 located adjacent to each other, for instance. A shape of the counter electrode insulating member 32 is a tubular shape having a circular or polygonal circumference, for example. Note that the shape of the counter electrode insulating member 32 is not limited to the aforementioned shape. The counter electrode insulating member 32 is formed in conformity to the shapes of the through hole 20b and the electrode conductive member 42, for example.

Each counter electrode insulating member 32 is provided for every two battery cells 100 located adjacent to each other except the battery cell 100 located lowermost, and continuously covers from at least a portion of the electrode active material layer 112 of one battery cell 100 out of the two battery cells 100 located adjacent to each other, the solid electrolyte layer 130 thereof, the counter electrode active material layer 122 thereof, the shared counter electrode current collector 121, the counter electrode active material layer 122 of the other battery cell 100, the solid electrolyte layer 130 thereof, and at least a portion of the electrode active material layer 112 thereof. As described above, since the counter electrode insulating member 32 covers the solid electrolyte layer 130 and the electrode active material layer 112 in addition to the counter electrode layer 120, it is less likely to expose the counter electrode layer 120 to the inner wall 25b even in case of a variation in width (the length in the z-axis direction) due to production tolerance of the counter electrode insulating member 32. Accordingly, it is less likely that the counter electrode layer 120 comes into contact with the electrode conductive member 42 on the inner wall 25b to cause a short circuit, so that reliability of the battery 1 can be improved. Note that the counter electrode insulating member 32 does not always have to cover the electrode active material layer 112. Meanwhile, the counter electrode insulating member 32 does not always have to cover the solid electrolyte layer 130, either.

The electrode insulating members 31 and the counter electrode insulating members 32 penetrate into asperities on inner side surfaces of the electrode active material layers 112, the counter electrode active material layers 122, and the solid electrolyte layers 130, thereby increasing adhesion strength and improving reliability of the battery 1. Here, each of the electrode active material layers 112, the counter electrode active material layers 122, and the solid electrolyte layers 130 can be formed by using a powder material. In this case, very fine asperities are present on the inner side surface of each of the layers.

Each of the electrode insulating members 31 and the counter electrode insulating members 32 is formed by using an insulating member having an electrical insulation property. For example, each of the electrode insulating members 31 and the counter electrode insulating members 32 contains a resin. The resin is an epoxy-based resin, for example. However, the resin is not limited thereto. Here, an inorganic material may be used as the insulating member. The insulating member usable therein is selected based on various characteristics including flexibility, gas barrier properties, shock resistance, heat resistance, and the like. The electrode insulating members 31 and the counter electrode insulating members 32 are formed by using the same material. Instead, the electrode insulating members 31 and the counter electrode insulating members 32 may be formed by using different materials from each other.

Here, in the vicinity of the opening position 21a of the through hole 20a, the electrode insulating member 31 may cover a portion of the principal surface 11 being an upper surface of the power generation element 5. In the power generation element 5 according to the present embodiment, the uppermost layer is the electrode current collector 111. Accordingly, even when the counter electrode conductive member 41 or the counter electrode current collecting terminal 51 extends to the principal surface 11, it is possible to keep the counter electrode conductive member 41 or the counter electrode current collecting terminal 51 from coming into contact with the electrode current collector 111 and causing a short circuit.

Meanwhile, in the vicinity of the opening position 22b of the through hole 20b, the counter electrode insulating member 32 may cover a portion of the principal surface 12 being a lower surface of the power generation element 5. In the power generation element 5 according to the present embodiment, the lowermost layer is the counter electrode current collector 121. Accordingly, even when the electrode conductive member 42 extends to the principal surface 12, it is possible to keep the electrode conductive member 42 from coming into contact with the counter electrode current collector 121 and causing a short circuit.

### 4. Conductive Members and Connecting Member

Next, the counter electrode conductive member 41, the electrode conductive member 42, and the connecting member 50 will be described.

The counter electrode conductive member 41 is disposed inside the through holes 20a as illustrated in FIG. 1. The counter electrode conductive member 41 is a conductive portion which covers the inner walls 25a of the respective through holes 20a of the battery cells 100 as well as the electrode insulating members 31, and is electrically connected to the counter electrode layers 120. To be more precise, the counter electrode conductive member 41 covers the electrode insulating members 31 and portions of the inner walls 25a of the respective through holes 20a of the battery cells 100 not covered with the electrode insulating members 31. The counter electrode conductive member 41 completely buries portions of the respective through holes 20a of the battery cells 100 other than the electrode insulating members 31. A clearance may be provided to a portion of at least any of between the counter electrode conductive member 41 and the inner walls 25a and between the counter electrode conductive member 41 and the electrode insulating members 31.

Respective inner side surfaces of the counter electrode current collector 121 and the counter electrode active material layer 122 are exposed to a portion of the inner wall 25a of each of the through holes 20a of the battery cells 100 not covered with the electrode insulating member 31. As a consequence, the counter electrode conductive member 41 comes into contact with the respective inner side surfaces of the counter electrode current collector 121 and the counter electrode active material layer 122 and is electrically connected to the counter electrode layer 120. Since the counter electrode active material layer 122 is formed from the powder material, very fine asperities are present thereon. The counter electrode conductive member 41 penetrates into the asperities on end surfaces of the counter electrode active material layers 122, thereby increasing adhesion strength of the counter electrode conductive member 41 and improving reliability of electrical connection.

The counter electrode conductive member 41 is electrically connected to the respective counter electrode layers 120 of the battery cells 100. That is to say, the counter electrode conductive member 41 has a function to electrically connect the respective battery cells 100 in parallel. As illustrated in FIG. 1, the counter electrode conductive member 41 covers substantially the entirety from lower ends to upper ends of the inner walls 25a of the respective through holes 20a of the battery cells 100 in a lump.

The counter electrode conductive member 41 extends from the opening position 22a of the through hole 20a at the principal surface 12 to the opening position 21a of the through hole 20a at the principal surface 11 while passing through the respective through holes 20a of the battery cells 100. That is to say, the counter electrode conductive member 41 penetrates from the principal surface 11 to the principal surface 12 of the power generation element 5 while passing through the respective through holes 20a of the battery cells 100. The counter electrode conductive member 41 functions as a penetrating electrode of the counter electrode which penetrates the power generation element 5, for example.

An end portion on the principal surface 11 side of the counter electrode conductive member 41 is in contact with the counter electrode current collecting terminal 51. An end portion on the principal surface 12 side of the counter electrode conductive member 41 is in contact with the connecting member 50.

The electrode conductive member 42 is disposed inside the through holes 20b as illustrated in FIG. 1. The electrode conductive member 42 is a conductive portion which covers the inner walls 25b of the respective through holes 20b of the battery cells 100 as well as the counter electrode insulating members 32, and is electrically connected to the electrode layers 110. To be more precise, the electrode conductive member 42 covers the counter electrode insulating members 32 and portions of the inner walls 25b of the respective through holes 20b of the battery cells 100 not covered with the counter electrode insulating members 32. The electrode conductive member 42 completely buries portions of the respective through holes 20b of the battery cells 100 other than the counter electrode insulating members 32. A clearance may be provided to a portion of at least any of between the electrode conductive member 42 and the inner walls 25b and between the electrode conductive member 42 and the counter electrode insulating members 32.

Respective inner side surfaces of the electrode current collector 111 and the electrode active material layer 112 are exposed to a portion of the inner wall 25b of each of the through holes 20b of the battery cells 100 not covered with the counter electrode insulating member 32. As a consequence, the electrode conductive member 42 comes into contact with the respective inner side surfaces of the electrode current collector 111 and the electrode active material layer 112 and is electrically connected to the electrode layer 110. Since the electrode active material layer 112 is formed from the powder material, very fine asperities are present thereon. The electrode conductive member 42 penetrates into the asperities on the inner side surfaces of the electrode active material layers 112, thereby increasing adhesion strength of the electrode conductive member 42 and improving reliability of electrical connection.

The electrode conductive member 42 is electrically connected to the respective electrode layers 110 of the battery cells 100. That is to say, the electrode conductive member 42 has a function to electrically connect the respective battery cells 100 in parallel. As illustrated in FIG. 1, the electrode conductive member 42 covers substantially the entirety from lower ends to upper ends of the inner walls 25b of the respective through holes 20b of the battery cells 100 in a lump.

The electrode conductive member 42 extends from the opening position 22b of the through hole 20b at the principal surface 12 to the opening position 21b of the through hole 20b at the principal surface 11 while passing through the respective through holes 20b of the battery cells 100. That is to say, the electrode conductive member 42 penetrates from the principal surface 11 to the principal surface 12 of the power generation element 5 while passing through the respective through holes 20b of the battery cells 100. The electrode conductive member 42 functions as a penetrating electrode of the electrode which penetrates the power generation element 5, for example.

An end portion on the principal surface 11 side of the electrode conductive member 42 is in contact with the electrode current collecting terminal 52. An end portion on the principal surface 12 side of the electrode conductive member 42 is exposed. The end portion on the principal surface 12 side of the electrode conductive member 42 may be covered with an insulating member such as the counter electrode insulating member 32 instead.

Each of the counter electrode conductive member 41 and the electrode conductive member 42 is formed by using a conductive resin material and the like. Alternatively, each of the counter electrode conductive member 41 and the electrode conductive member 42 may be formed by using a metal material such as solder. The conductive material usable therein is selected based on various characteristics including flexibility, gas barrier properties, shock resistance, heat resistance, solder wettability, and the like. The counter electrode conductive member 41 and the electrode conductive member 42 are formed by using the same material, but may be formed by using different materials from each other instead. Meanwhile, each of the counter electrode conductive member 41 and the electrode conductive member 42 may be composed of two or more materials. For example, a material used at a central portion may be a different from a material used at an outer peripheral portion of the inner wall 25a side or the inner wall 25b side.

The connecting member 50 is disposed on the principal surface 12 side of the power generation element 5. The connecting member 50 is connected to the counter electrode conductive member 41 at the opening position 22a. The connecting member 50 covers the principal surface 12 in the vicinity of the opening position 22a and is also connected to the principal surface 12. The connecting member 50 increases an electrical connection area between the counter electrode conductive member 41 and the principal surface 12, that is, the counter electrode layer 120 of the battery cell 100 located lowermost. Moreover, connection between the counter electrode conductive member 41 and the counter electrode current collector 121 at the lowermost layer is protected by the connecting member 50.

The connecting member 50 is formed by using a conductive material. For example, the connecting member 50 is formed by using a metal material such as aluminum, copper, nickel, stainless steel, and solder. Alternatively, the connecting member 50 may be formed by using a conductive resin material and the like. For example, the connecting member 50 can be formed in accordance with a method such as printing, plating, and soldering. Alternatively, the connecting member 50 may be formed by drawing the counter electrode conductive member 41 from the through hole 20a to outside of the principal surface 12 and being connected to the principal surface 12. In other words, the connecting member 50 may be a portion of the counter electrode conductive member 41.

Here, the battery 1 does not always have to include the connecting member 50.

The electrode insulating members 31, the counter electrode insulating members 32, the counter electrode conductive member 41, and the electrode conductive member 42 are formed as described below, for example.

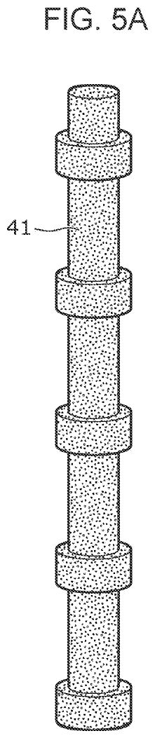

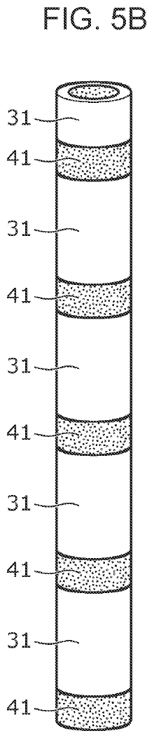

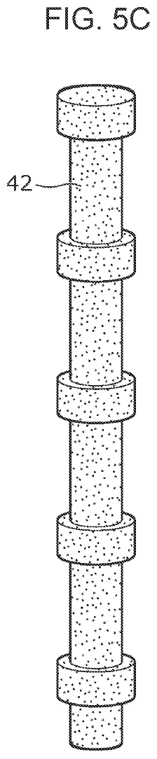

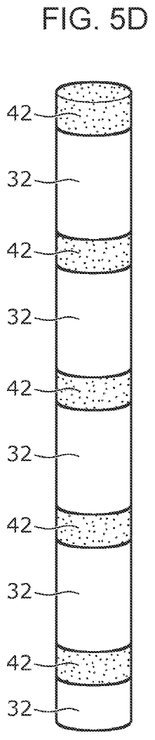

In the formation of the electrode insulating members 31, the counter electrode insulating members 32, the counter electrode conductive member 41, and the electrode conductive member 42, a first composite member illustrated in FIG. 5B which is composed of the electrode insulating members 31 and the counter electrode conductive member 41 and a second composite member illustrated in FIG. 5D which is composed of the counter electrode insulating members 32 and the electrode conductive member 42 are formed, for example.

FIG. 5A is a perspective view of the counter electrode conductive member 41. FIG. 5B is a perspective view of the first composite member composed of the electrode insulating members 31 and the counter electrode conductive member 41. FIG. 5C is a perspective view of the electrode conductive member 42. FIG. 5D is a perspective view of the second composite member composed of counter electrode insulating members 32 and the electrode conductive member 42. Although surfaces of the counter electrode conductive member 41 and the electrode conductive member 42 are provided with patterns in FIGS. 5A to 5D for the purpose of visibility, these patterns do not represent that the counter electrode conductive member 41 and the electrode conductive member 42 are actually provided with patterns.

The counter electrode conductive member 41 as illustrated in FIG. 5A is prepared for forming the first composite member. The counter electrode conductive member 41 is a conductive body formed by subjecting the conductive material to processing such as molding and cutting, for example. The counter electrode conductive member 41 is a columnar body that includes thick portions and thin portions in light of the thickness of the column. Each thin portion corresponds to a location to dispose the electrode insulating member 31. Next, as illustrated in FIG. 5B, outer peripheral surfaces of the thin portions of the counter electrode conductive member 41 are covered with the electrode insulating members 31. In this instance, the electrode insulating members 31 are formed such that outer peripheral surfaces of the thick portions of the counter electrode conductive member 41 and outer peripheral surfaces of the electrode insulating members 31 form a single continuous surface. Thus, the first composite member composed of the electrode insulating members 31 and the counter electrode conductive member 41 is formed. The first composite member has the same shape as the through hole formed by concatenating the respective through holes 20a of the battery cells 100. Although the first composite member has the columnar shape in the example illustrated in FIG. 5B, the first composite member may have a different shape. The first composite member thus formed is inserted into the through holes 20a.

The electrode conductive member 42 as illustrated in FIG. 5C is prepared for forming the second composite member. The electrode conductive member 42 is a conductive body formed by subjecting the conductive material to processing such as molding and cutting, for example. The electrode conductive member 42 is a columnar body that includes thick portions and thin portions in light of the thickness of the column. Each thin portion corresponds to a location to dispose the counter electrode insulating member 32. Next, as illustrated in FIG. 5D, outer peripheral surfaces of the thin portions of the electrode conductive member 42 are covered with the counter electrode insulating members 32. In this instance, the counter electrode insulating members 32 are formed such that outer peripheral surfaces of the thick portions of the electrode conductive member 42 and outer peripheral surfaces of the counter electrode insulating members 32 form a single continuous surface. Thus, the second composite member composed of the counter electrode insulating members 32 and the electrode conductive member 42 is formed. The second composite member has the same shape as the through hole formed by concatenating the respective through holes 20b of the battery cells 100. Although the second composite member has the columnar shape in the example illustrated in FIG. 5D, the second composite member may have a different shape. The second composite member thus formed is inserted into the through holes 20b.

### 5. Current Collecting Terminals

Next, the counter electrode current collecting terminal 51 and the electrode current collecting terminal 52 will be described with reference to FIGS. 1 and 2 again.

The counter electrode current collecting terminal 51 is disposed on the principal surface 11 side of the power generation element 5. The counter electrode current collecting terminal 51 is connected to the counter electrode conductive member 41 at the opening position 21a. The counter electrode current collecting terminal 51 is a conductive terminal connected to the counter electrode conductive member 41. The counter electrode current collecting terminal 51 is one of external connection terminals of the battery 1, which is a negative extraction terminal in the present embodiment. A portion of the counter electrode current collecting terminal 51 is in contact with the electrode insulating member 31. Here, the counter electrode current collecting terminal 51 does not always have to be in contact with the electrode insulating member 31. Alternatively, the counter electrode current collecting terminal 51 may be connected to the counter electrode conductive member 41 while interposing another conductive connecting layer or the like therebetween.

As illustrated in FIG. 2, the counter electrode current collecting terminal 51 is located on an inner side of the through hole 20a in plan view, which is located on an inner side relative to an outer periphery of the electrode insulating member 31 in the present embodiment. As a consequence, the counter electrode current collecting terminal 51 is not in contact with the principal surface 11, and is insulated from the principal surface 11, that is, the electrode layer 110 of the battery cell 100 located uppermost.

The electrode current collecting terminal 52 is disposed on the principal surface 11 side of the power generation element 5. The electrode current collecting terminal 52 is connected to the electrode conductive member 42 at the opening position 21b. The electrode current collecting terminal 52 is a conductive terminal connected to the electrode conductive member 42. The electrode current collecting terminal 52 is one of the external connection terminals of the battery 1, which is a positive extraction terminal in the present embodiment. Here, the electrode current collecting terminal 52 may be connected to the electrode conductive member 42 while interposing another conductive connecting layer or the like therebetween.

As illustrated in FIG. 2, the electrode current collecting terminal 52 is located on an inner side of the through hole 20b in plan view, which is located on an inner side relative to an outer periphery of the electrode conductive member 42 in the present embodiment. Here, the electrode current collecting terminal 52 may spread to the outside of the through hole 20b in plan view. That is to say, the electrode current collecting terminal 52 may cover a portion of the principal surface 11 and may be in contact with the principal surface 11. Meanwhile, the electrode current collecting terminal 52 may be disposed at a position not overlapping the through hole 20b in plan view. In this case, the electrode current collecting terminal 52 is not directly connected to the electrode conductive member 42, but is electrically connected while interposing the electrode current collector 111 on the uppermost layer therebetween.

In plan view, the counter electrode current collecting terminal 51 and the electrode current collecting terminal 52 are arranged in the x-axis direction, for example. A positional relationship between the counter electrode current collecting terminal 51 and the electrode current collecting terminal 52 in plan view is not limited to a particular relationship, and is designed depending on a type of usage of the battery 1, for example.

Each of the counter electrode current collecting terminal 51 and the electrode current collecting terminal 52 is a projecting terminal provided on the principal surface 11 side of the power generation element 5. However, shapes of the counter electrode current collecting terminal 51 and the electrode current collecting terminal 52 are not limited to particular shapes. The counter electrode current collecting terminal 51 and the electrode current collecting terminal 52 may undergo a required insulation treatment and then spread in a plate-like fashion along the principal surface 11.

Each of the counter electrode current collecting terminal 51 and the electrode current collecting terminal 52 is formed by using a conductive material. For example, each of the counter electrode current collecting terminal 51 and the electrode current collecting terminal 52 is formed by using a metal material such as aluminum, copper, nickel, stainless steel, and solder. Alternatively, each of the counter electrode current collecting terminal 51 and the electrode current collecting terminal 52 may be formed by using a conductive resin material and the like. For example, each of the counter electrode current collecting terminal 51 and the electrode current collecting terminal 52 can be formed in accordance with a method such as printing, plating, and soldering. Alternatively, the counter electrode current collecting terminal 51 may be formed by causing the counter electrode conductive member 41 to project from the through hole 20a to the outside of the principal surface 11. In other words, the counter electrode current collecting terminal 51 may be a portion of the counter electrode conductive member 41. Likewise, the electrode current collecting terminal 52 may be formed by causing the electrode conductive member 42 to project from the through hole 20b to the outside of the principal surface 11. In other words, the electrode current collecting terminal 52 may be a portion of the electrode conductive member 42.

### 6. Usage Example

Next, a usage example of the battery 1 will be described. Note that the following usage example is a mere example and a mode of using the battery 1 is not limited to a particular method.

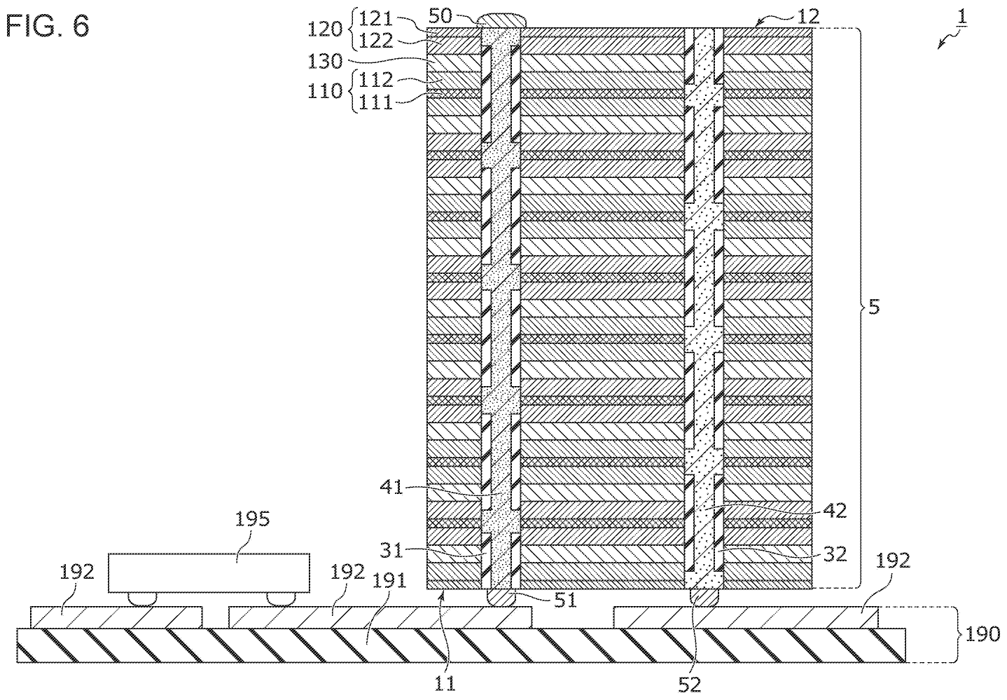

The battery 1 according to the present embodiment is used by being mounted on a circuit board, for example. FIG. 6 is a sectional view illustrating a usage example of the battery 1. FIG. 6 illustrates the battery 1 mounted on a circuit board 190, which is in a state of turning the battery 1 illustrated in FIG. 1 upside down.

As illustrated in FIG. 6, the circuit board 190 for mounting the battery 1 includes an insulative plate-like base body 191 and circuit wiring 192. The circuit wiring 192 is a circuit pattern formed on the base body 191.

The counter electrode current collecting terminal 51 of the battery 1 is connected to a portion of the circuit wiring 192, for example. Meanwhile, the electrode current collecting terminal 52 of the battery 1 is connected to a different portion of the circuit wiring 192, for example. Thus, electric power is supplied from the battery 1 to an electronic device 195 mounted on the circuit board 190 and connected to the circuit wiring 192.

In the battery 1, the counter electrode current collecting terminal 51 and the electrode current collecting terminal 52 being the extraction terminals of the positive and negative electrodes are provided at the same principal surface 11. Since the counter electrode current collecting terminal 51 and the electrode current collecting terminal 52 are disposed on the inner side of the outer periphery of the power generation element 5 in plan view, the battery 1 can be mounted on the circuit board 190 with a minimum mounting area and a low profile.

Moreover, provision of the counter electrode current collecting terminal 51 and the electrode current collecting terminal 52 at the principal surface 11 can also shorten a wiring length of the circuit wiring 192 easily, so that wiring resistance and noise attributed to a current flowing on the wiring can be reduced.

Note that any of batteries according to respective embodiments to be described below may be mounted on the circuit board 190 instead.

### 7. Summary

As described above, according to the battery 1 of the present embodiment, the battery cells 100 are laminated while being connected in parallel. Thus, it is possible to realize the battery 1 that achieves the high capacity density and the large capacity at the same time.

Meanwhile, each of the counter electrode conductive member 41 and the electrode conductive member 42 has the function to electrically connect the respective battery cells 100 in parallel. As illustrated in FIG. 1, the counter electrode conductive member 41 and the electrode conductive member 42 are formed inside the respective through holes 20a and inside the respective through holes 20b of the battery cells 100, respectively. Therefore, it is not necessary to form a structure required for the parallel connection of the battery cells 100 on the outside of a side surface of the power generation element 5. Accordingly, the battery 1 can be downsized so that the capacity density of the battery 1 can be increased. It is possible to reduce the mounting area when the battery 1 is mounted on the board, for example.

In the meantime, on the inner wall 25a of each through hole 20a, the electrode layer 110 is covered with the electrode insulating member 31. On the inner wall 25b of each through hole 20b, the counter electrode layer 120 is covered with the counter electrode insulating member 32. For this reason, it is possible to suppress a short circuit due to contact between the electrode layer 110 and the counter electrode conductive member 41 and a short circuit due to contact between the electrode layer 110 and the counter electrode layer 120 inside the through hole 20a. Likewise, it is possible to suppress a short circuit due to contact between the counter electrode layer 120 and the electrode conductive member 42 and contact between the electrode layer 110 and the counter electrode layer 120 inside the through hole 20b. Accordingly, reliability of the battery 1 can be improved.

Moreover, since a structure required for the parallel connection of the battery cells 100 is not present on the outside of the side surface of the power generation element 5, it is possible to suppress the occurrence of a short circuit associated with a misalignment of a conductive member or the like due to an impact from the outside and the like. Thus, it is possible to improve reliability of the battery 1.

In the meantime, the counter electrode conductive member 41 extends from the opening position 22a of the through hole 20a located at the principal surface 12 to the opening position 21a of the through hole 20a located at the principal surface 11 while passing through the respective through holes 20a of the battery cells 100. Likewise, the electrode conductive member 42 extends from the opening position 22b of the through hole 20b located at the principal surface 12 to the opening position 21b of the through hole 20b located at the principal surface 11 while passing through the respective through holes 20b of the battery cells 100. Thus, it is possible to establish connection between the positive electrode and the negative electrode of the power generation element 5 on the principal surface 11 side or the principal surface 12 side of the power generation element 5.

Meanwhile, since the counter electrode current collecting terminal 51 and the electrode current collecting terminal 52 are provided on the same principal surface 11 side, it is possible to extract the electric currents from both of the positive electrode and the negative electrode of the power generation element 5 on the principal surface 11 side. Accordingly, it is possible to assemble compact mounting of the battery 1. For example, a pattern of connection terminals (also referred to as footprints) to be formed on the board can be reduced in size. Moreover, it is possible to carry out mounting in a state of arranging the principal surface 11 of the battery 1 and the board in parallel, so that low profile mounting on the board can be realized. Reflow soldering and the like can be used for the mounting. As described above, it is possible to realize the battery 1 that is excellent in mountability.

In the meantime, a terminal for extracting the current need not be formed as a consequence of a process such as causing the current collector to project in the form of a tab from a portion on the side surface of the power generation element 5. Accordingly, the side surface of the power generation element 5 of the battery 1 can be formed into a flat side surface by cutting the laminated battery cells 100 in a lump, for example. Adoption of the lump cutting accurately determines the respective areas of the electrode layer 110, the counter electrode layer 120, and the solid electrolyte layer 130 while avoiding a gradual increase and a gradual decrease in film thickness at starting and terminating ends when coating each layer. Thus, a variation in capacity among the battery cells 100 is reduced so that accuracy of a battery capacity can be enhanced.

### Embodiment 2

Next, a description will be given of Embodiment 2. The following description will be focused on different features from those of the Embodiment 1 while omitting or simplifying explanations of features in common.

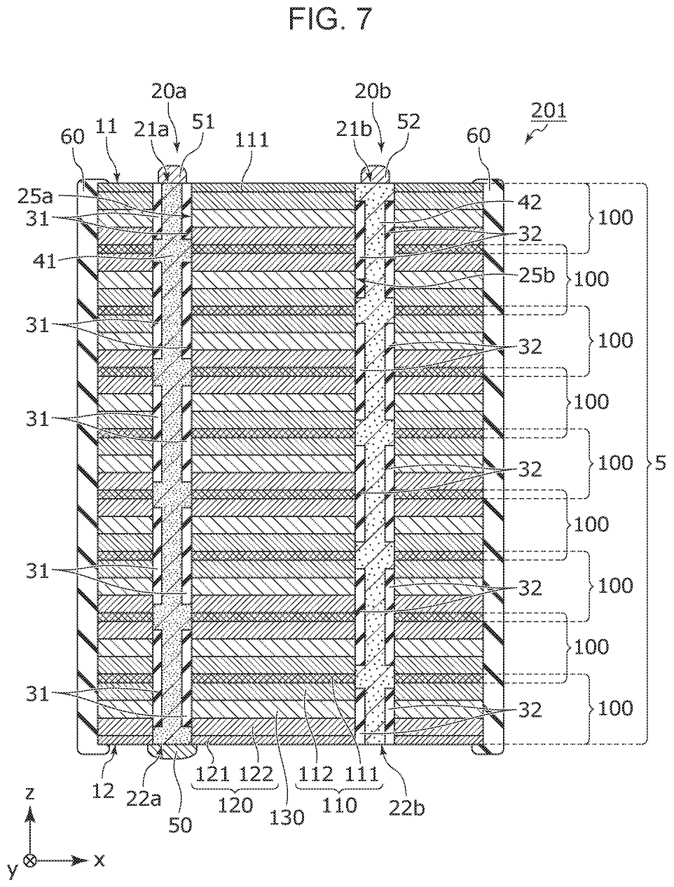

FIG. 7 is a sectional view of a battery 201 according to the present embodiment. As illustrated in FIG. 7, in comparison with the battery 1 according to the Embodiment 1, the battery 201 is different in that the battery 201 further includes a side surface insulating layer 60.

The side surface insulating layer 60 covers a side surface of the power generation element 5. The side surface insulating layer 60 covers all of the side surfaces of the power generation element 5, for example. This configuration can achieve suppression of collapse of the materials of the respective layers on the side surface of the power generation element 5, enhancement of weather resistance, enhancement of shock resistance, and the like, thereby improving reliability of the battery 201.

Alternatively, the side surface insulating layer 60 may cover respective end portions of the principal surface 11 and the principal surface 12. In this way, it is possible to suppress detachment of the electrode current collector 111 and the counter electrode current collector 121 disposed at the principal surface 11 and the principal surface 12, thereby further improving the reliability of the battery 201.

The side surface insulating layer 60 is formed by using an insulating material having an electrical insulation property. For example, the side surface insulating layer 60 contains a resin. The resin is an epoxy-based resin, for example. However, the resin is not limited thereto. Here, an inorganic material may be used as the insulating material. The insulating material usable therein is selected based on various characteristics including flexibility, gas barrier properties, shock resistance, heat resistance, and the like.

Note that the side surface insulating layer 60 may be provided to a battery according to each of the embodiments to be described later.

### Embodiment 3

Next, a description will be given of Embodiment 3. The following description will be focused on different features from those of the Embodiments 1 and 2 while omitting or simplifying explanations of features in common.

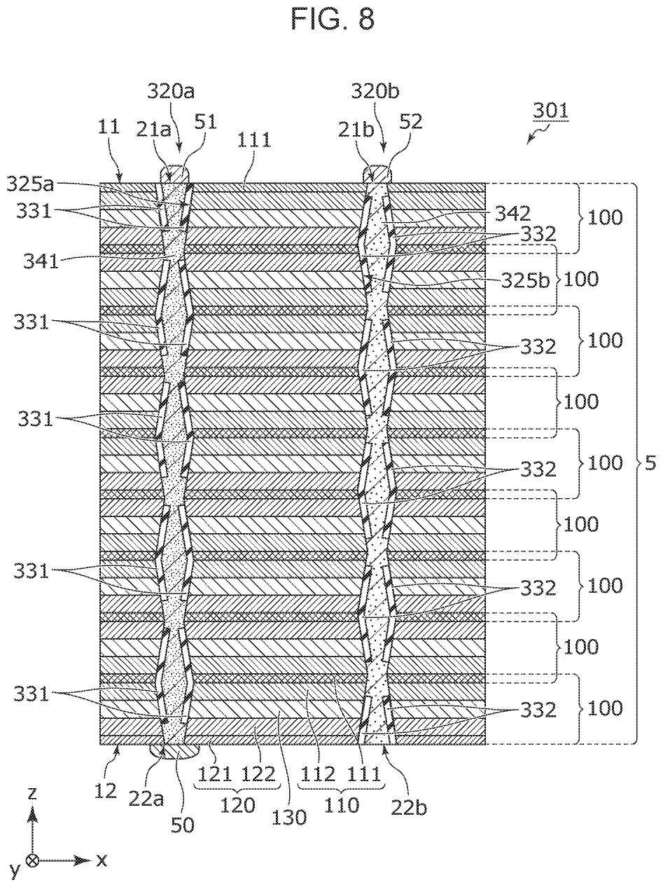

FIG. 8 is a sectional view of a battery 301 according to the present embodiment. As illustrated in FIG. 8, in comparison with the battery 1 according to the Embodiment 1, the battery 301 is different in that the battery cells 100 are provided with through holes 320a and through holes 320b instead of providing the battery cells 100 with the through holes 20a and the through holes 20b. Moreover, in comparison with the battery 1 according to the Embodiment 1, the battery 301 is also different in that the battery 301 includes electrode insulating members 331, counter electrode insulating members 332, a counter electrode conductive member 341, and an electrode conductive member 342 instead of the electrode insulating members 31, the counter electrode insulating members 32, the counter electrode conductive member 41, and the electrode conductive member 42.

Each of the battery cells 100 is provided with the through hole 320a and the through hole 320b. The through hole 320a is an example of the first through hole. The through hole 320b is an example of the second through hole. The through hole 320a and the through hole 320b are mainly different from the through hole 20a and the through hole 20b in that the through hole 320a and the through hole 320b include an inner wall 325a and an inner wall 325b which are inclined with respect to the direction of lamination.

In each of the through holes 320a of the battery cells 100, a sectional shape of the through hole 320a at the electrode layer 110 in the direction perpendicular to the direction of lamination is different from a sectional shape of the through hole 320a at the counter electrode layer 120 in the direction perpendicular to the direction of lamination. This makes it easier to form the electrode insulating members 331 on the inner walls 325a.

To be more precise, in each of the through holes 320a of the battery cells 100, a sectional area of the through hole 320a at the electrode layer 110 in the direction perpendicular to the direction of lamination is larger than a sectional area of the through hole 320a at the counter electrode layer 120 in the direction perpendicular to the direction of lamination. The direction perpendicular to the direction of lamination is equivalent to a direction of extension of the respective layers. Accordingly, the through hole 320a spreads at a position of the electrode layer 110 whereby the inner wall 325a of the through hole 320a takes on a structure which causes the electrode layer 110 to recede and causes the counter electrode layer 120 to bulge. This makes it possible to provide the insulating member to a portion of the electrode layer 110 that is recessed as a consequence of the spread of the through hole 320a, for example. Thus, the structure that causes the electrode insulating member 331 to cover the electrode layer 110 is formed easily. Meanwhile, it is possible to secure a large space for forming the counter electrode conductive member 341 inside the through hole 320a even when the electrode insulating member 331 covers the electrode layer 110, so that an increase in resistance of the counter electrode conductive member 341 can be suppressed. As a consequence, it is possible to enhance large current characteristics of the battery 301.

In each of the through holes 320b of the battery cells 100, a sectional shape of the through hole 320b at the electrode layer 110 in the direction perpendicular to the direction of lamination is different from a sectional shape of the through hole 320b at the counter electrode layer 120 in the direction perpendicular to the direction of lamination. This makes it easier to form the counter electrode insulating members 332 on the inner walls 325b.

To be more precise, in each of the through holes 320b of the battery cells 100, a sectional area of the through hole 320b at the counter electrode layer 120 in the direction perpendicular to the direction of lamination is larger than a sectional area of the through hole 320b at the electrode layer 110 in the direction perpendicular to the direction of lamination. Accordingly, the through hole 320b spreads at a position of the counter electrode layer 120 whereby the inner wall 325b of the through hole 320b takes on a structure which causes the counter electrode layer 120 to recede and causes the electrode layer 110 to bulge. This makes it possible to provide the insulating member to a portion of the counter electrode layer 120 that is recessed as a consequence of the spread of the through hole 320b, for example. Thus, the structure that causes the counter electrode insulating member 332 to cover the counter electrode layer 120 is formed easily. Meanwhile, it is possible to secure a large space for forming the electrode conductive member 342 inside the through hole 320b even when the counter electrode insulating member 332 covers the counter electrode layer 120, so that an increase in resistance of the electrode conductive member 342 can be suppressed. As a consequence, it is possible to enhance the large current characteristics of the battery 301.

The inner wall 325a of each of the through holes 320a of the battery cells 100 and the inner wall 325b of each of the through holes 320b of the battery cells 100 are inclined with respect to the direction of lamination, respectively. That is to say, each of the through holes 320a of the battery cells 100 and each of the through holes 320b of the battery cells 100 have the tapered inner wall 325a and the tapered inner wall 325b, respectively. Accordingly, it is possible to differentiate between the sectional areas of the through hole 320a and the through hole 320b at the electrode layer 110 and the counter electrode layer 120 easily. In the present embodiment, the entire surfaces of the inner walls 325a and the entire surfaces of the inner walls 325b are inclined with respect to the direction of lamination.

Meanwhile, in each inner wall 325a, the inner side surface of the electrode layer 110 constituting a portion of the inner wall 325a is inclined with respect to the direction of lamination. Accordingly, the electrode insulating member 331 to cover the electrode layer 110 on the inner wall 325a can be formed by a process such as applying the insulating member in the direction of lamination. Thus, it is possible to form the electrode insulating member 331 easily.

In the meantime, in each inner wall 325b, the inner side surface of the counter electrode layer 120 constituting a portion of the inner wall 325b is inclined with respect to the direction of lamination. Accordingly, the counter electrode insulating member 332 to cover the counter electrode layer 120 on the inner wall 325b can be formed by a process such as applying the insulating member in the direction of lamination. Thus, it is possible to form the counter electrode insulating member 332 easily.

Meanwhile, each of the through holes 320a and the through holes 320b of the battery cells 100 has a truncated cone shape, for example. Accordingly, no corners are formed on the inner walls 325a of the through holes 320a and on the inner walls 325b of the through holes 320b, so that electric field concentration can be suppressed inside the through holes 320a and inside the through holes 320b. Moreover, the through holes 320a and the through holes 320b can be formed easily with a drill having a tapered angle, for example. Note that the shape of each of the through holes 320a and the through holes 320b is not limited to the truncated cone shape but may be any other shapes including a truncated polygonal pyramid shape such as a truncated quadrangular pyramid shape and a truncated hexagonal pyramid shape.

The respective through holes 320a of the battery cells 100 are concatenated. Likewise, the respective through holes 320b of the battery cells 100 are concatenated. This configuration makes it easier to form the insulating members and the conductive members inside the through holes 320a and the through holes 320b.

In the meantime, the respective through holes 320a and the respective through holes 320b of the battery cells 100 have substantially the same volume and the same shape. Accordingly, a variation in capacity among the battery cells 100 can be suppressed as with the Embodiment 1.

The electrode insulating member 331 has the same characteristics as those of the electrode insulating member 31 except that the electrode insulating member 331 covers the electrode layer 110 on the inner wall 325a which is inclined with respect to the direction of lamination, for example. Meanwhile, the counter electrode insulating member 332 has the same characteristics as those of the counter electrode insulating member 32 except that the counter electrode insulating member 332 covers the counter electrode layer 120 on the inner wall 325b which is inclined with respect to the direction of lamination, for example.

The counter electrode conductive member 341 has the same characteristics as those of the counter electrode conductive member 41 except that the counter electrode conductive member 341 is in contact with and electrically connected to the counter electrode layer 120 on the inner wall 325a and covers the electrode insulating member 331. The counter electrode conductive member 341 is electrically connected to the respective counter electrode layers 120 of the battery cells 100. On the other hand, the electrode conductive member 342 has the same characteristics as those of the electrode conductive member 42 except that the electrode conductive member 342 is in contact with and electrically connected to the electrode layer 110 on the inner wall 325b and covers the counter electrode insulating member 332. The electrode conductive member 342 is electrically connected to the respective electrode layers 110 of the battery cells 100.

As described above, the counter electrode conductive member 341 is disposed inside the through holes 320a. Meanwhile, the electrode conductive member 342 is disposed inside the through holes 320b. Each of the counter electrode conductive member 341 and the electrode conductive member 342 has a function to electrically connect the respective battery cells 100 in parallel. Hence, it is possible to realize the battery 301 that achieves the high capacity density and high reliability at the same time as with the Embodiment 1.

Meanwhile, in the present embodiment, each through hole 320b is provided such that the sectional area of the through hole 320b at the electrode layer 110 in the direction perpendicular to the direction of lamination is small. Accordingly, an opening area of the through hole 320b is small at the opening position 21b. As a consequence, the electrode current collecting terminal 52 is connected to the electrode conductive member 342 at the opening position 21b and is in contact with the principal surface 11 in the vicinity of the opening position 21b, thus being connected to the principal surface 11 as well.

The through holes 320a, the through holes 320b, the electrode insulating members 331, and the counter electrode insulating members 332 according to the present embodiment are formed as described below, for example. In battery cells 100 of the present embodiment, the through holes 320a, the through holes 320b, the electrode insulating members 331, and the counter electrode insulating members 332 are formed in the respective battery cells 100 before forming the power generation element 5, for example.

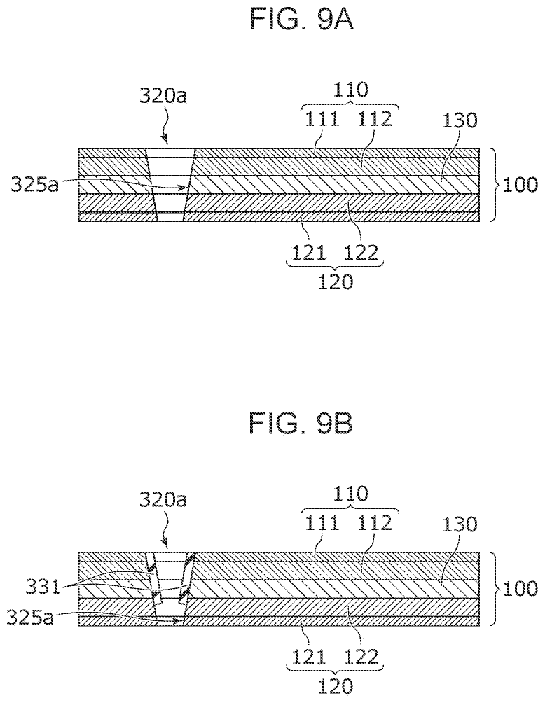

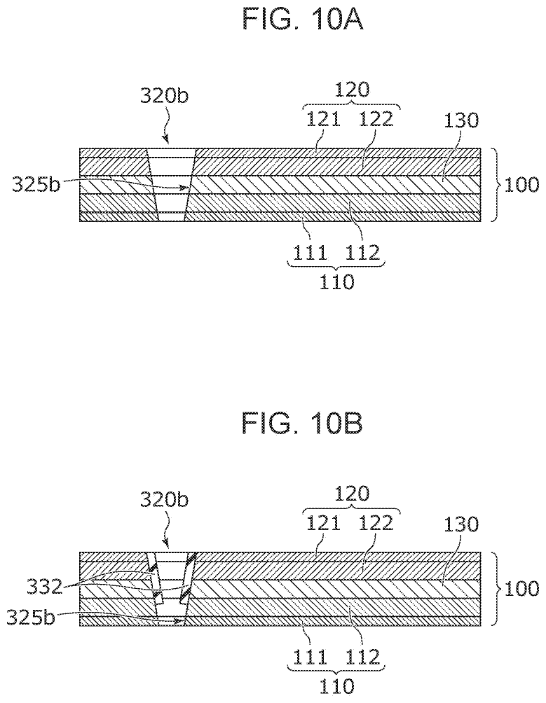

FIG. 9A is a sectional view for explaining a process of forming the through hole 320a. FIG. 9B is a sectional view for explaining a process of forming the electrode insulating member 331. FIG. 10A is a sectional view for explaining a process of forming the through hole 320b. FIG. 10B is a sectional view for explaining a process of forming the counter electrode insulating member 332. Note that FIGS. 9A to 10B illustrate only a portion in the vicinity of the through hole 320a or the through hole 320b of the battery cell 100.

First, a description will be given of the formation of the through hole 320a and the electrode insulating member 331. As illustrated in FIG. 9A, the through hole 320a is formed in the battery cell 100. For example, the battery cell 100 is disposed such that the electrode layer 110 is located above the counter electrode layer 120, and the through hole 320a is formed by inserting a drill and the like having a tapered angle that is gradually reduced toward a tip end side into the battery cell 100 from above downward. As a consequence, the inner wall 325a is inclined with respect to the direction of lamination and the sectional area of the through hole 320a at the electrode layer 110 in the direction perpendicular to the direction of lamination becomes larger than the sectional area of the through hole 320a at the counter electrode layer 120 in the direction perpendicular to the direction of lamination.

Next, as illustrated in FIG. 9B, the electrode insulating member 331 to cover the electrode layer 110 is formed on the inner wall 325a of the through hole 320a. For example, the electrode insulating member 331 is formed into an annular shape by applying the insulating member onto the inner wall 325a from above the battery cell 100 in accordance with an ink jet method and the like. Since the inner wall 325a is inclined with respect to the direction of lamination, the inner wall 325a can easily be coated with the insulating member even from above the battery cell 100.

Next, a description will be given of the formation of the through hole 320b and the counter electrode insulating member 332. As illustrated in FIG. 10A, the through hole 320b is formed in the battery cell 100. For example, the battery cell 100 is disposed such that the counter electrode layer 120 is located above the electrode layer 110, and the through hole 320b is formed by inserting a drill and the like having a tapered angle that is gradually reduced toward a tip end side into the battery cell 100 from above downward. As a consequence, the inner wall 325b is inclined with respect to the direction of lamination and the sectional area of the through hole 320b at the counter electrode layer 120 in the direction perpendicular to the direction of lamination becomes larger than the sectional area of the through hole 320b at the electrode layer 110 in the direction perpendicular to the direction of lamination.

The formation of the through hole 320b may be carried out before or after the formation of the through hole 320a described above. Alternatively, the through hole 320a and the through hole 320b may be formed at the same time by inserting the drills and the like from above and below the battery cell 100. Otherwise, the formation of the through hole 320b may be carried out after the formation of the through hole 320a and the electrode insulating member 331.

Next, as illustrated in FIG. 10B, the counter electrode insulating member 332 to cover the counter electrode layer 120 is formed on the inner wall 325b of the through hole 320b. For example, the counter electrode insulating member 332 is formed into an annular shape by applying the insulating member onto the inner wall 325b from above the battery cell 100 in accordance with the ink jet method and the like. Since the inner wall 325b is inclined with respect to the direction of lamination, the inner wall 325b can easily be coated with the insulating member even from above the battery cell 100.

The power generation element 5 can be formed by laminating the battery cells 100 each provided with the through hole 320a, the through hole 320b, the electrode insulating member 331, and the counter electrode insulating member 332 as described above while aligning positions of the through holes 320a and the through holes 320b. Here, the formation of the counter electrode conductive member 341 and the electrode conductive member 342 may be carried out before the formation of the power generation element 5 or after the formation of the power generation element 5.

### Embodiment 4

Next, a description will be given of Embodiment 4. The following description will be focused on different features from those of the Embodiments 1 to 3 while omitting or simplifying explanations of features in common.

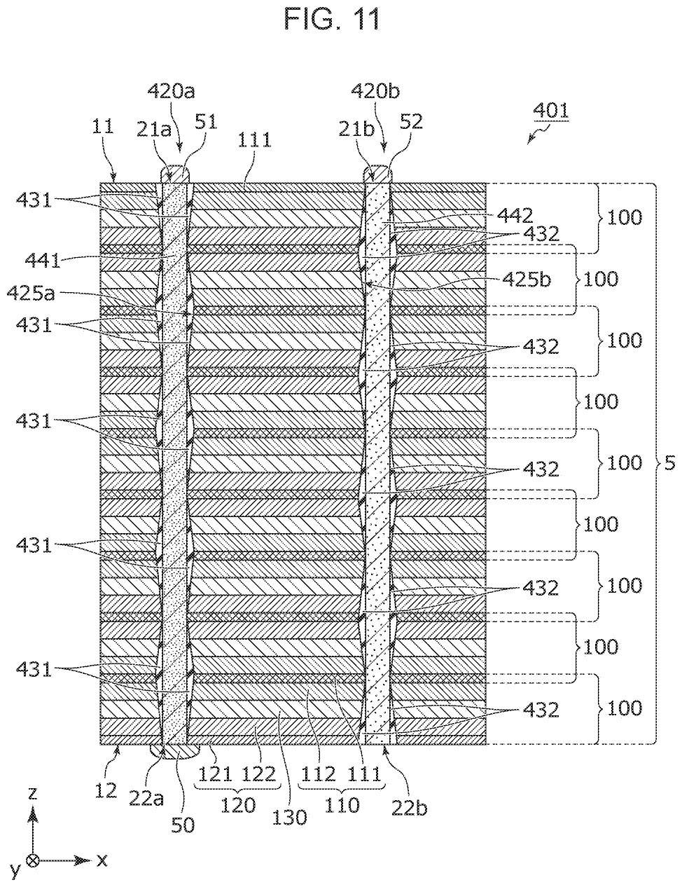

FIG. 11 is a sectional view of a battery 401 according to the present embodiment. As illustrated in FIG. 11, in comparison with the battery 1 according to the Embodiment 1, the battery 401 is different in that the battery cells 100 are provided with through holes 420a and through holes 420b instead of providing the battery cells 100 with the through holes 20a and the through holes 20b. Moreover, in comparison with the battery 1 according to the Embodiment 1, the battery 401 is also different in that the battery 401 includes electrode insulating members 431, counter electrode insulating members 432, a counter electrode conductive member 441, and an electrode conductive member 442 instead of the electrode insulating members 31, the counter electrode insulating members 32, the counter electrode conductive member 41, and the electrode conductive member 42.

Each of the battery cells 100 is provided with the through hole 420a and the through hole 420b. The through hole 420a is an example of the first through hole. The through hole 420b is an example of the second through hole. The through hole 420a and the through hole 420b are mainly different from the through hole 20a and the through hole 20b in that the through hole 420a and the through hole 420b include an inner wall 425a and an inner wall 425b which are partially inclined with respect to the direction of lamination.

The through hole 420a has the same characteristics as those of the through hole 320a according to the Embodiment 3 except that a portion of the inner wall 425a of the through hole 420a is parallel to the direction of lamination, for example. Meanwhile, the through hole 420b has the same characteristics as those of the through hole 320b according to the Embodiment 3 except that a portion of the inner wall 425b of the through hole 420b is parallel to the direction of lamination, for example.

In each of the through holes 420a of the battery cells 100, a sectional area of the through hole 420a at the electrode layer 110 in the direction perpendicular to the direction of lamination is larger than a sectional area of the through hole 420a at the counter electrode layer 120 in the direction perpendicular to the direction of lamination. Accordingly, the inner wall 425a of the through hole 420a takes on a structure which causes the electrode layer 110 to recede and causes the counter electrode layer 120 to bulge.

A portion of the inner wall 425a of each of the through holes 420a of the battery cells 100 is inclined with respect to the direction of lamination. To be more precise, in the inner wall 425a, the inner side surface of the electrode layer 110 constituting the portion of the inner wall 425a is inclined with respect to the direction of lamination. Meanwhile, in the inner wall 425a, a portion of the inner side surface of the solid electrolyte layer 130 and a portion of the inner side surface of the counter electrode layer 120 may also be inclined with respect to the direction of lamination.

On the other hand, a portion of the inner wall 425a of each of the through holes 420a of the battery cells 100 is parallel to the direction of lamination. To be more precise, in the inner wall 425a, at least a portion of the inner side surface of the counter electrode layer 120 constituting the portion of the inner wall 425a is parallel to the direction of lamination. Accordingly, the through hole 420a does not have a structure in which the space of the through hole 420a is reduced at the position corresponding to the counter electrode layer 120, so that an increase in resistance of the counter electrode conductive member 441 can be suppressed at the position to be disposed in the space and connected to the counter electrode layer 120. As a consequence, it is possible to enhance the large current characteristics of the battery 401.

In each of the through holes 420b of the battery cells 100, a sectional area of the through hole 420b at the counter electrode layer 120 in the direction perpendicular to the direction of lamination is larger than a sectional area of the through hole 420b at the electrode layer 110 in the direction perpendicular to the direction of lamination. Accordingly, the inner wall 425b of the through hole 420b takes on a structure which causes the counter electrode layer 120 to recede and causes the electrode layer 110 to bulge.

A portion of the inner wall 425b of each of the through holes 420b of the battery cells 100 is inclined with respect to the direction of lamination. To be more precise, in the inner wall 425b, the inner side surface of the counter electrode layer 120 constituting the portion of the inner wall 425b is inclined with respect to the direction of lamination. Meanwhile, in the inner wall 425b, a portion of the inner side surface of the solid electrolyte layer 130 and a portion of the inner side surface of the electrode layer 110 may also be inclined with respect to the direction of lamination.

On the other hand, a portion of the inner wall 425b of each of the through holes 420b of the battery cells 100 is parallel to the direction of lamination. To be more precise, in the inner wall 425b, at least a portion of the inner side surface of the electrode layer 110 constituting the portion of the inner wall 425b is parallel to the direction of lamination. Accordingly, the through hole 420b does not have a structure in which the space of the through hole 420b is reduced at the position corresponding to the electrode layer 110, so that an increase in resistance of the electrode conductive member 442 can be suppressed at the position to be disposed in the space and connected to the electrode layer 110. As a consequence, it is possible to enhance the large current characteristics of the battery 401.

In the meantime, each of the through holes 420a and the through holes 420b of the battery cells 100 has a truncated cone shape, for example. Accordingly, it is unlikely that corners are formed on the inner walls 425a of the through holes 420a and on the inner walls 425b of the through holes 420b, so that electric field concentration can be suppressed inside the through holes 420a and inside the through holes 420b.

The respective through holes 420a of the battery cells 100 are concatenated. Likewise, the respective through holes 420b of the battery cells 100 are concatenated. This configuration makes it easier to form the insulating members and the conductive members inside the through holes 420a and the through holes 420b.

In the meantime, the respective through holes 420a and the respective through holes 420b of the battery cells 100 have substantially the same volume and the same shape. Accordingly, a variation in capacity among the battery cells 100 can be suppressed as with the Embodiment 1.

The electrode insulating member 431 has the same characteristics as those of the electrode insulating member 31 except that its thickness is not constant and that the electrode insulating member 431 covers the portion of the inner wall 425a which is inclined with respect to the direction of lamination, for example. A surface of the electrode insulating member 431 on an opposite side of the inner wall 425a side is parallel to the direction of lamination. The surface of the electrode insulating member 431 on the opposite side of the inner wall 425a side is continuous with each of the portions of the inner walls 425a being parallel to the direction of lamination, thus forming a single surface that extends from the principal surface 11 to the principal surface 12.

The counter electrode insulating member 432 has the same characteristics as those of the counter electrode insulating member 32 except that its thickness is not constant and that the counter electrode insulating member 432 covers the portion of the inner wall 425b which is inclined with respect to the direction of lamination, for example. A surface of the counter electrode insulating member 432 on an opposite side of the inner wall 425b side is parallel to the direction of lamination. The surface of the counter electrode insulating member 432 on the opposite side of the inner wall 425b side is continuous with each of the portions of the inner walls 425b being parallel to the direction of lamination, thus forming a single surface that extends from the principal surface 11 to the principal surface 12.

The counter electrode conductive member 441 has the same characteristics as those of the counter electrode conductive member 41 except that counter electrode conductive member 441 is in contact with and electrically connected to the counter electrode layer 120 at the portion of the inner wall 425a parallel to the direction of lamination, and covers the electrode insulating member 431. The counter electrode conductive member 441 is electrically connected to the respective counter electrode layers 120 of the battery cells 100. Sectional areas of the counter electrode conductive member 441 in the direction perpendicular to the direction of lamination are constant. Accordingly, it is possible to homogenize electric current characteristics in the counter electrode conductive member 441. Moreover, it is easier to form the counter electrode conductive member 441 which is designed to be a simple shape. The shape of the counter electrode conductive member 441 is a columnar shape, for example. Here, the shape of the counter electrode conductive member 441 may be any other shapes such as a prism shape.

The electrode conductive member 442 has the same characteristics as those of the electrode conductive member 42 except that electrode conductive member 442 is in contact with and electrically connected to the electrode layer 110 at the portion of the inner wall 425b parallel to the direction of lamination, and covers the counter electrode insulating member 432. The electrode conductive member 442 is electrically connected to the respective electrode layers 110 of the battery cells 100. Sectional areas of the electrode conductive member 442 in the direction perpendicular to the direction of lamination are constant. Accordingly, it is possible to homogenize electric current characteristics in the electrode conductive member 442. Moreover, it is easier to form the electrode conductive member 442 which is designed to be a simple shape. The shape of the electrode conductive member 442 is a columnar shape, for example. Here, the shape of the electrode conductive member 442 may be any other shapes such as a prism shape.

As described above, the counter electrode conductive member 441 is disposed inside the through holes 420a. Meanwhile, the electrode conductive member 442 is disposed inside the through holes 420b. Each of the counter electrode conductive member 441 and the electrode conductive member 442 has a function to electrically connect the respective battery cells 100 in parallel. Thus, it is possible to realize the battery 401 that achieves the high capacity density and high reliability at the same time as with the Embodiment 1.

Meanwhile, in the present embodiment, each through hole 420b is provided such that the sectional area of the through hole 420b at the electrode layer 110 in the direction perpendicular to the direction of lamination is smaller. Accordingly, an opening area of the through hole 420b is smaller at the opening position 21b. As a consequence, the electrode current collecting terminal 52 is connected to the electrode conductive member 442 at the opening position 21b and is in contact with the principal surface 11 in the vicinity of the opening position 21b, thus being connected to the principal surface 11 as well.

The electrode insulating members 431 and the counter electrode conductive member 441 according to the present embodiment are formed as described below, for example.

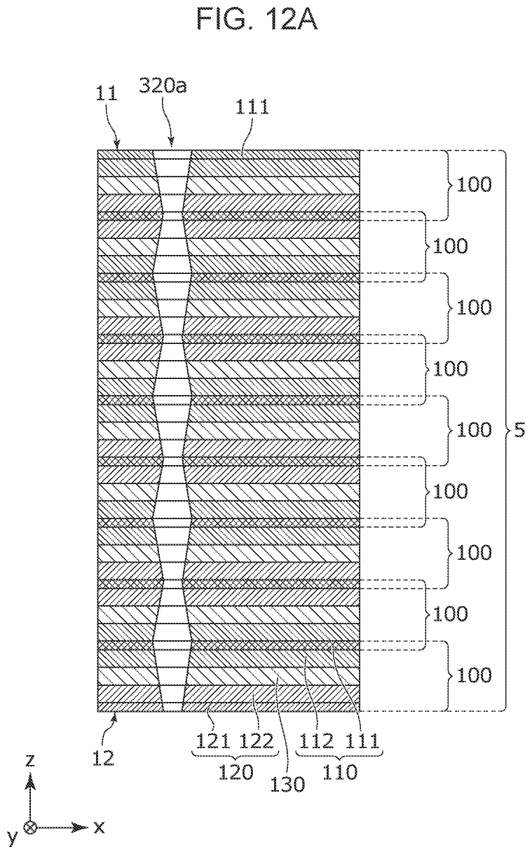

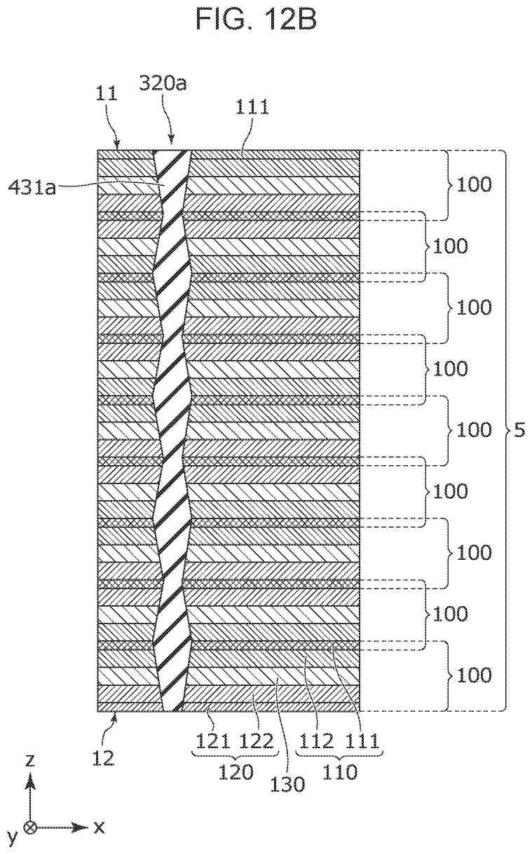

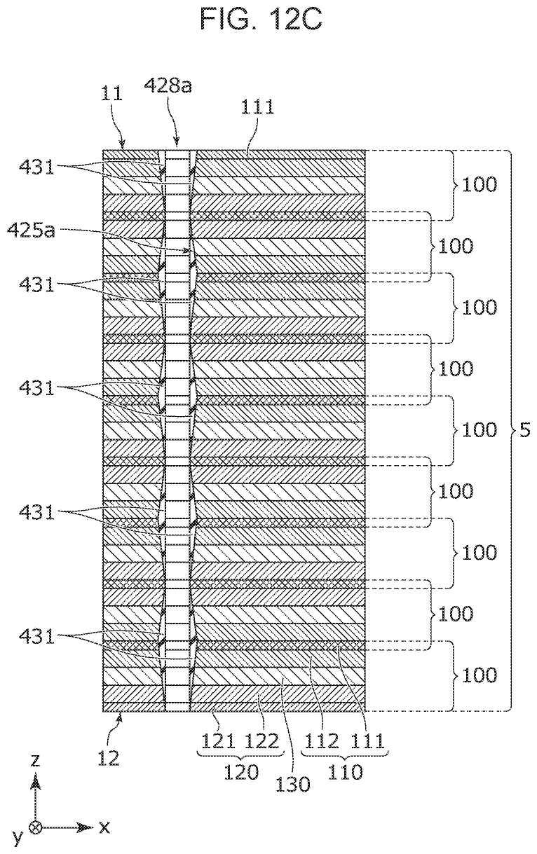

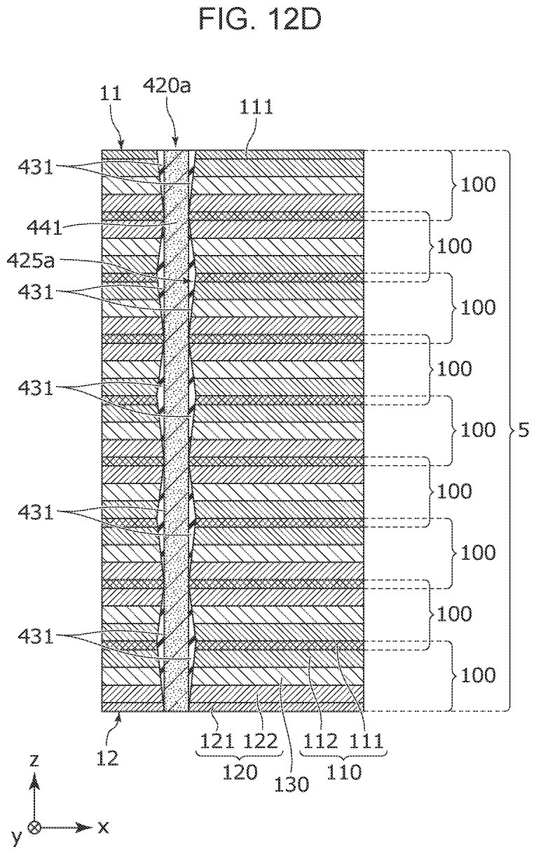

FIGS. 12A to 12D are sectionals views for explaining processes of forming the electrode insulating members 431 and the counter electrode conductive member 441. Note that FIGS. 12A to 12D illustrate only a portion in the vicinity of the position of the power generation element 5 where the through hole 420a is formed.

First, the power generation element 5 in which the through hole 320a is formed in each of the battery cells 100 is prepared as illustrated in FIG. 12A. In this instance, the respective through holes 320a of the battery cells 100 are concatenated while aligning central positions thereof when viewed in the direction of lamination. The power generation element 5 is formed by laminating the battery cells 100 illustrated in FIG. 9A, for example. Here, the power generation element 5 provided with the through holes 420a as illustrated in FIG. 11 may be prepared instead.

Next, the through holes 320a formed in the respective battery cells 100 are filled with an insulating member 431a as illustrated in FIG. 12B.

Next, a columnar hole 428a that extends in a direction of concatenation of the through holes 320a and penetrates the power generation element 5 is formed in a region including the filled insulating member 431a as illustrated in FIG. 12C. For example, the columnar hole 428a is formed by inserting a drill and the like at a position where the insulating member 431a coincides with the center when viewed in the direction of lamination. A sectional area of the columnar hole 428a in the direction perpendicular to the direction of lamination is smaller than the sectional area of the through hole 320a at the electrode layer 110 in the direction perpendicular to the direction of lamination and is larger than the sectional area of the through hole 320a at the counter electrode layer 120 in the direction perpendicular to the direction of lamination. Accordingly, the electrode insulating members 431 that cover the respective electrode layers 110 of the battery cells 100 are formed from the insulating member 431a that remains inside the through holes 320a after the formation of the columnar hole 428a. Meanwhile, a portion of the bulging portion of each of the counter electrode layers 120 of the battery cells 100 is scraped off, whereby the through hole 320a is formed into the shape of the through holes 420a provided with the inner walls 425a. Each of the counter electrode layers 120 of the battery cells 100 is exposed in each of the inner walls 425a.

Next, as illustrated in FIG. 12D, the counter electrode conductive member 441 to be electrically connected to the respective counter electrode layers 120 of the battery cells 100 is formed by filling the formed columnar hole 428a with the conductive material. After the above-described processes, the electrode insulating members 431 and the counter electrode conductive member 441 are formed in the through holes 420a. As described above, the electrode insulating members 431 and the counter electrode conductive member 441 are formed in a lump in the respective through holes 420a of the battery cells 100 by using the shapes of the through holes 420a. Thus, productivity can be improved.

Meanwhile, since the through holes 320b as illustrated in FIG. 10A are formed in the respective battery cells 100, the counter electrode insulating members 432 and the electrode conductive member 442 can be formed inside the through holes 420b in accordance with the same methods as those adopted for the electrode insulating members 431 and the counter electrode conductive member 441.

### Embodiment 5

Next, a description will be given of Embodiment 5. The following description will be focused on different features from those of the Embodiments 1 to 4 while omitting or simplifying explanations of features in common.

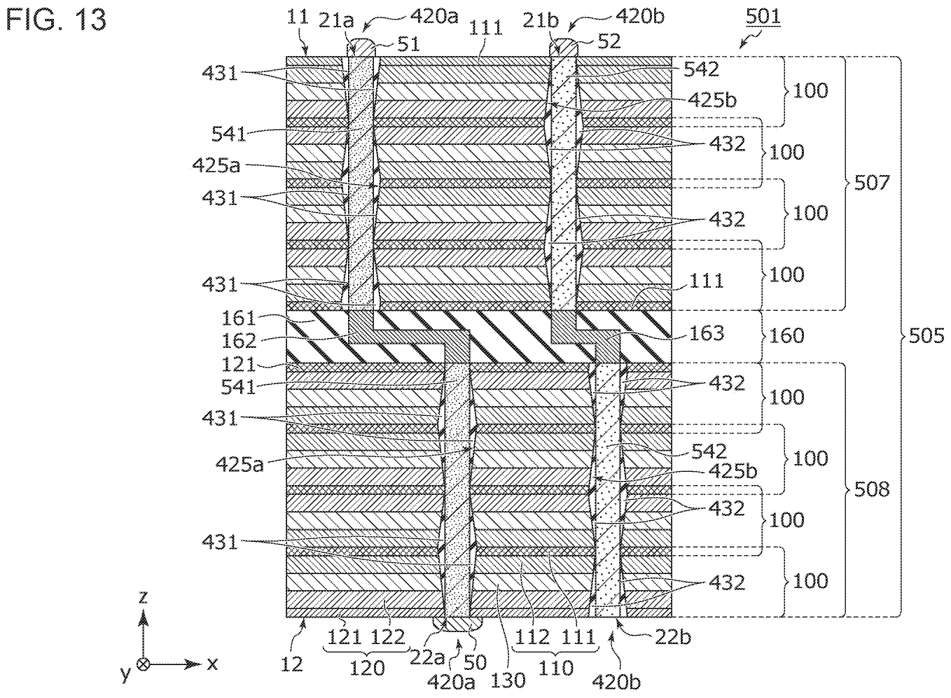

FIG. 13 is a sectional view of a battery 501 according to the present embodiment. As illustrated in FIG. 13, in comparison with the battery 401 according to the Embodiment 4, the battery 501 is different in that the battery 501 includes a power generation element 505, a counter electrode conductive member 541, and an electrode conductive member 542 instead of the power generation element 5, the counter electrode conductive member 441, and the electrode conductive member 442.

The power generation element 505 includes the battery cells 100 and a connecting layer 160. In the power generation element 505, a portion of the battery cells 100 among the battery cells 100 constitute a cell laminated body 507 while another portion of the battery cells 100 among the battery cells 100 constitute a cell laminated body 508. The battery cells 100 constituting the cell laminated body 507 and the battery cells 100 constituting the cell laminated body 508 do not overlap one another. It is also possible to say that the power generation element 505 includes the cell laminated body 507 and the cell laminated body 508. The cell laminated body 507 is an example of a first cell laminated body. The cell laminated body 508 is an example of a second cell laminated body. In the example illustrated in FIG. 13, the cell laminated body 507 and the cell laminated body 508 each include multiple, namely, four battery cells 100. Here, the number of the cell laminated body included in the power generation element 505 and the number of the battery cells 100 included in each of the cell laminated body 507 and the cell laminated body 508 is not limited to a particular number. The number of the battery cells 100 constituting the cell laminated body 507 may be equal to or different from the number of the battery cells 100 constituting the cell laminated body 508.

The battery cells 100 included in each of the cell laminated body 507 and the cell laminated body 508 are electrically connected in parallel.

In the power generation element 505, each of the battery cells 100 is provided with the through hole 420a and the through hole 420b which penetrate each battery cell 100 in the direction of lamination.

In each of the cell laminated body 507 and the cell laminated body 508, the battery cells 100 are laminated in such a way as to concatenate the through holes 420a and to concatenate the through holes 420b.

The respective through holes 420a of the battery cells 100 in the cell laminated body 507 constitute one through hole that penetrates the cell laminated body 507. The respective through holes 420b of the battery cells 100 in the cell laminated body 507 constitute one through hole that penetrates the cell laminated body 507.

Meanwhile, the respective through holes 420a of the battery cells 100 in the cell laminated body 508 constitute one through hole that penetrates the cell laminated body 508. The respective through holes 420b of the battery cells 100 in the cell laminated body 508 constitute one through hole that penetrates the cell laminated body 508.

The through holes 420a in the cell laminated body 507 are located at a different position from that of the through holes 420a in the cell laminated body 508 when viewed in the direction of lamination. Meanwhile, the through holes 420b in the cell laminated body 507 are located at a different position from that of the through holes 420b in the cell laminated body 508 when viewed in the direction of lamination. Accordingly, even when the number of the laminated battery cells 100 is increased and a problem is likely to occur as a consequence of forming the through holes at the same position of all of the battery cells 100, the through holes 420a and the through holes 420b can instead be formed while changing the positions thereof. For example, it is possible to avoid a situation where formation of the insulating members and the like inside the through holes is complicated by the increase in number of the battery cells 100.

The counter electrode conductive member 541 has the same characteristics as those of the counter electrode conductive member 441 except that the respective through holes 420a of the battery cells 100 in the cell laminated body 507 are disposed separately from the respective through holes 420a of the battery cells 100 in the cell laminated body 508, for example.

The electrode conductive member 542 has the same characteristics as those of the electrode conductive member 442 except that the respective through holes 420b of the battery cells 100 in the cell laminated body 507 are disposed separately from the respective through holes 420b of the battery cells 100 in the cell laminated body 508, for example.

The connecting layer 160 is disposed between the cell laminated body 507 and the cell laminated body 508. The connecting layer 160 includes an insulating layer 161, and a conductive member 162 as well as a conductive member 163 which are disposed in the insulating layer 161.

The insulating layer 161 is disposed between the cell laminated body 507 and the cell laminated body 508. The insulating layer 161 insulates the conductive member 162 from the electrode layer 110 and insulates the conductive member 163 from the counter electrode layer 120 in the connecting layer 160. Meanwhile, the insulating layer 161 is disposed between the conductive member 162 and the conductive member 163.

The conductive member 162 is buried in the insulating layer 161. The conductive member 162 is not in contact with any of the electrode layers 110 of the battery cells 100. The conductive member 162 is connected to an end portion on the connecting layer 160 side of the counter electrode conductive member 541 disposed in the through holes 420a in the cell laminated body 507 and to an end portion on the connecting layer 160 side of the counter electrode conductive member 541 disposed in the through holes 420a in the cell laminated body 508. In this way, the two counter electrode conductive members 541 are electrically connected to each other. Accordingly, the counter electrode layers 120 of all of the battery cells 100 in the power generation element 505 are electrically connected to one another by using the counter electrode conductive members 541.

The conductive member 163 is buried in the insulating layer 161. The conductive member 163 is not in contact with any of the counter electrode layers 120 of the battery cells 100. The conductive member 163 is connected to an end portion on the connecting layer 160 side of the electrode conductive member 542 disposed in the through holes 420b in the cell laminated body 507 and to an end portion on the connecting layer 160 side of the electrode conductive member 542 disposed in the through holes 420b in the cell laminated body 508. In this way, the two electrode conductive members 542 are electrically connected to each other. Accordingly, the electrode layers 110 of all of the battery cells 100 in the power generation element 505 are electrically connected to one another by using the electrode conductive members 542.

Here, instead of the through holes 420a and the through holes 420b, the respective battery cells 100 may be provided with the through holes according to the Embodiment 1 or 3.

### EMBODIMENT 6

Next, a description will be given of Embodiment 6. The following description will be focused on different features from those of the Embodiments 1 to 5 while omitting or simplifying explanations of features in common.

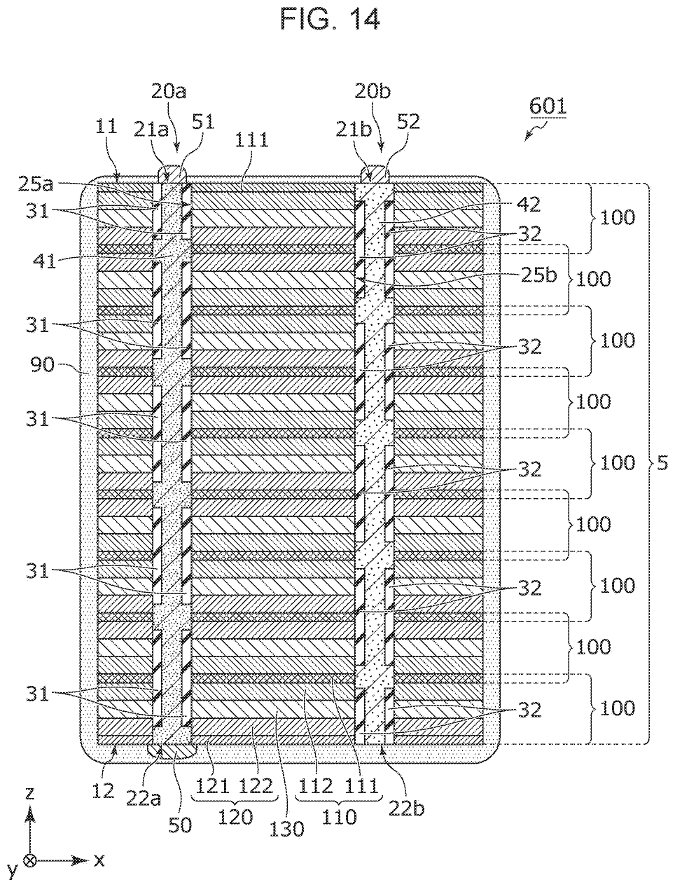

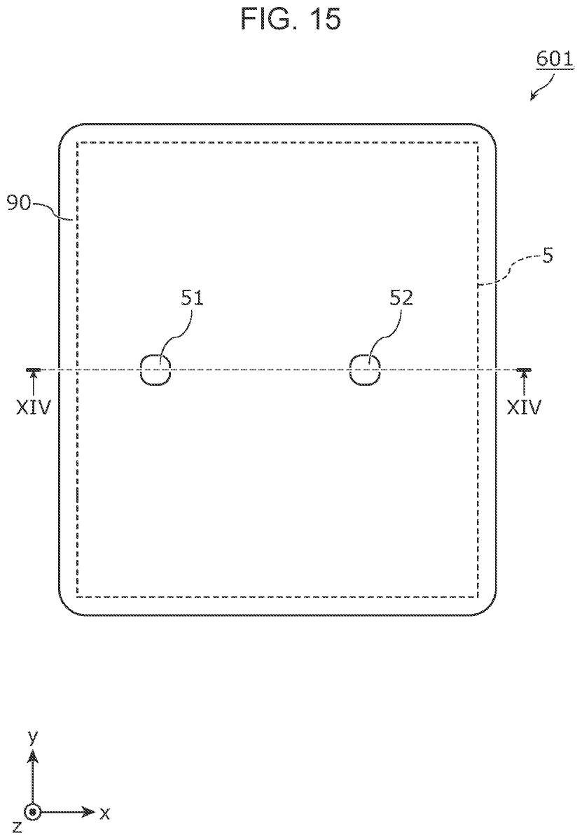

FIG. 14 is a sectional view of a battery 601 according to the present embodiment. FIG. 15 is a top plan view of the battery 601 according to the present embodiment. Here, FIG. 14 illustrates a section taken along the XIV-XIV line in FIG. 15. As illustrated in FIGS. 14 and 15, in comparison with the battery 1 according to the Embodiment 1, the battery 601 is different in that the battery 601 further includes a sealing member 90.

The sealing member 90 exposes at least a portion of each of the counter electrode current collecting terminal 51 and the electrode current collecting terminal 52, and seals the power generation element 5 at the same time. The sealing member 90 is provided in such a way as not to expose the power generation element 5, the electrode insulating members 31, the counter electrode insulating members 32, the counter electrode conductive member 41, the electrode conductive member 42, and the connecting member 50.

The sealing member 90 is formed by using an insulating material having an electrical insulation property, for example. Publicly known materials for battery sealing members such as a sealant can be used as the insulating material. A resin material can be used as the insulating material, for example. Here, the insulating material may be an insulative and non-ion conductive material. For example, the insulating material may be at least one of epoxy resin, acrylic resin, polyimide resin, and silsesquioxane.

Here, the sealing member 90 may contain different insulating materials. For example, the sealing member 90 may have a multilayer structure. Respective layers in the multilayer structure may be formed by using different materials and have different properties.

The sealing member 90 may contain a granular metal oxide material. Such metal oxide materials usable therefor include silicon oxide, aluminum oxide, titanium oxide, zinc oxide, cerium oxide, iron oxide, tungsten oxide, zirconium oxide, calcium oxide, zeolite, glass, and the like. For example, the sealing member 90 may be formed by using a resin material in which particles made of such a metal oxide material are dispersed.

A grain size of the metal oxide material is less than or equal to an interval between the electrode current collector 111 and the counter electrode current collector 121. A shape of grains of the metal oxide material is a spherical shape, an oval spherical shape, a rod shape, or the like but is not limited to these shapes.

Provision of the sealing member 90 can improve reliability of the battery 601 in various perspectives including mechanical strength, short-circuit prevention, moisture prevention, and so forth.

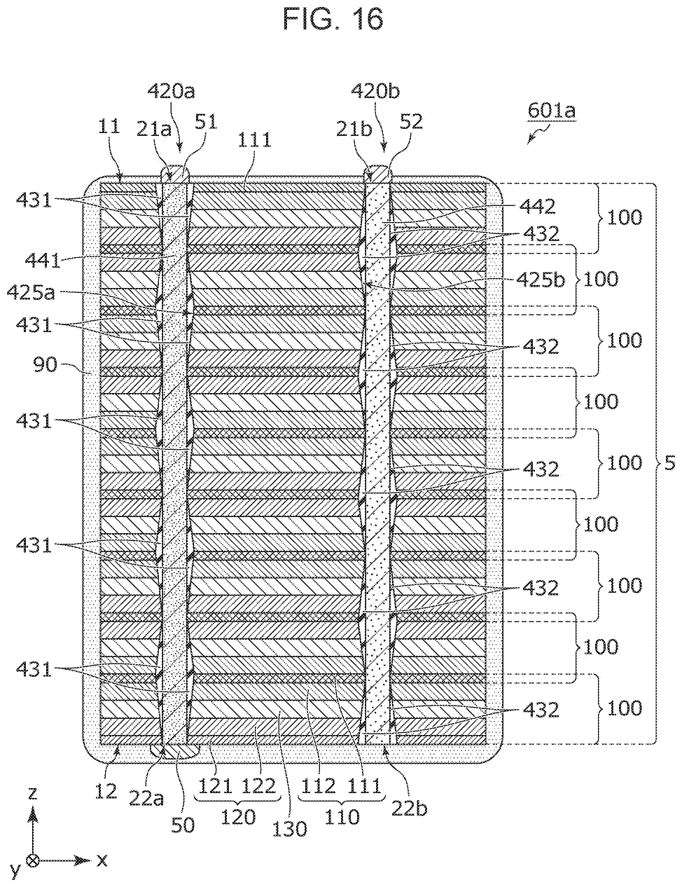

Although the example of further providing the battery 1 according to the Embodiment 1 with the sealing member 90 has been described herein, the batteries according to other embodiments may further include the sealing member 90 likewise. For example, the battery 401 according to the Embodiment 4 may further include the sealing member 90 as in a battery 601a illustrated in FIG. 16. FIG. 16 is a sectional view of the battery 601a according to another example of the present embodiment. In this case as well, the sealing member 90 exposes at least a portion of each of the counter electrode current collecting terminal 51 and the electrode current collecting terminal 52, and covers the power generation element 5, the electrode insulating members 431, the counter electrode insulating members 432, the counter electrode conductive member 441, the electrode conductive member 442, and the connecting member 50 so as not to be exposed.

### Embodiment 7

Next, a description will be given of Embodiment 7. The Embodiment 7 will describe a circuit board that includes the battery according to any of the above-described embodiments. The following description will be focused on different features from those of the Embodiments 1 to 6 while omitting or simplifying explanations of features in common.

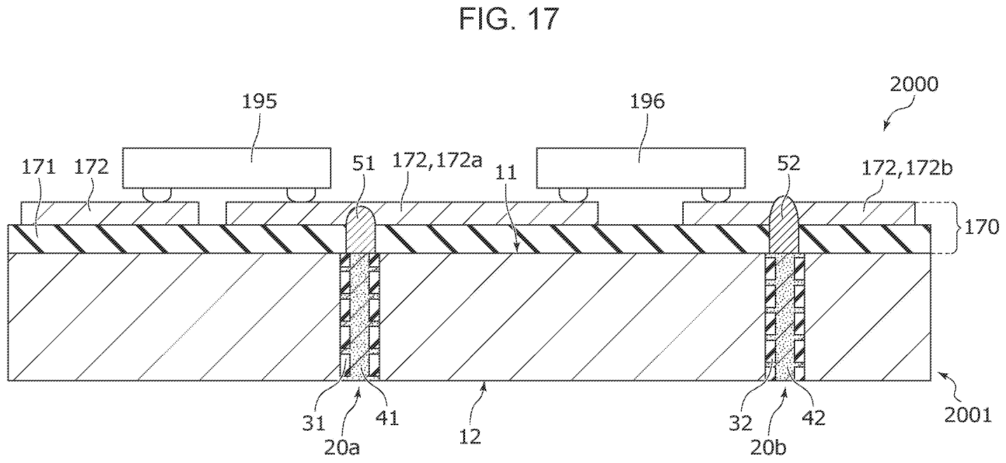

FIG. 17 is a sectional view of a circuit board 2000 according to the present embodiment. As illustrated in FIG. 17, the circuit board 2000 is a mounting board for mounting the electronic device 195 and an electronic device 196, for example. For example, each of the electronic device 195 and the electronic device 196 is any of a resistor, a capacitor, an inductor, a semiconductor chip, and the like. The number of the electronic devices to be mounted on the circuit board 2000 is not limited to a particular number.

The circuit board 2000 includes a battery 2001 and a circuit pattern layer 170.

The battery 2001 is any one of the batteries 1, 201, 301, 401, 501, 601, and 601a according to the above-described embodiments. In FIG. 17, illustration of a detailed structure of the battery 2001 is omitted for the sake of visibility and only the through hole 20a, the through hole 20b, the electrode insulating members 31, the counter electrode insulating members 32, the counter electrode conductive member 41, the electrode conductive member 42, the counter electrode current collecting terminal 51, and the electrode current collecting terminal 52 of the battery 2001 are demonstrated therein. Meanwhile, although the through hole 20a, the through hole 20b, the electrode insulating members 31, the counter electrode insulating members 32, the counter electrode conductive member 41, and the electrode conductive member 42 of the battery 1 according to the Embodiment 1 are representatively illustrated in FIG. 17, the battery 2001 may be provided with the through holes, the insulating members, and the conductive members according to any of the embodiments other than the Embodiment 1.

The circuit pattern layer 170 is laminated on the battery 2001. The circuit pattern layer 170 is disposed on the principal surface 11 side of the power generation element included in the battery 2001. The circuit pattern layer 170 includes a wiring insulating layer 171 and circuit wiring 172.

The wiring insulating layer 171 is disposed on the principal surface 11. In the example illustrated in FIG. 17, a width (an area) of the wiring insulating layer 171 is equal to a width (an area) of the battery 2001. Instead, the width (the area) of the wiring insulating layer 171 may be smaller than or larger than the width (the area) of the battery 2001. The circuit wiring 172 is formed on a surface on the opposite side to the principal surface 11 side of the wiring insulating layer 171.

The wiring insulating layer 171 is formed from an insulating material, and a general board insulating member such as an insulating film or an insulating board can be used. Meanwhile, the wiring insulating layer 171 may be a coated layer of the insulating material coated on the battery 2001. Alternatively, the wiring insulating layer 171 may be a portion of the sealing member 90.

In the circuit board 2000, the counter electrode current collecting terminal 51 and the electrode current collecting terminal 52 penetrate the wiring insulating layer 171 and project from the opposite side to the principal surface 11 of the wiring insulating layer 171.

The circuit wiring 172 is disposed on the opposite side to the principal surface 11 side of the wiring insulating layer 171. The circuit wiring 172 is a circuit pattern formed on the wiring insulating layer 171. The circuit wiring 172 is general printed board wiring, for example. The circuit wiring 172 may be a conductive pattern formed in accordance with a different method. The electronic device 195 and the electronic device 196 are connected to the circuit wiring 172. The circuit wiring 172 includes a first line 172a and a second line 172b. The first line 172a is an example of a portion of the circuit wiring 172. The second line 172b is an example of another portion of the circuit wiring 172.

The counter electrode current collecting terminal 51 and the electrode current collecting terminal 52 are connected to the circuit wiring 172. Specifically, the counter electrode current collecting terminal 51 is connected to the first line 172a. Meanwhile, the electrode current collecting terminal 52 is connected to the second line 172b. Accordingly, the counter electrode conductive member 41 is electrically connected to the first line 172a while interposing the counter electrode current collecting terminal 51 therebetween. Meanwhile, the electrode conductive member 42 is electrically connected to the second line 172b while interposing the electrode current collecting terminal 52 therebetween. The first line 172a and the second line 172b are located away from each other and are not in contact with each other.

In the circuit board 2000, the counter electrode current collecting terminal 51 does not penetrate the circuit wiring 172 and a portion of the counter electrode current collecting terminal 51 is buried in the circuit wiring 172. The electrode current collecting terminal 52 penetrates the circuit wiring 172 and a tip end of the electrode current collecting terminal 52 is exposed. Here, positional relationships of the counter electrode current collecting terminal 51 and the electrode current collecting terminal 52 with the circuit wiring 172 are not limited to particular relationships as long as these terminals are connected to the circuit wiring 172. For example, the counter electrode current collecting terminal 51 does not always have to penetrate the circuit wiring 172. Meanwhile, the electrode current collecting terminal 52 does not always have to penetrate the circuit wiring 172. In the meantime, a tip end of at least one of the counter electrode current collecting terminal 51 and the electrode current collecting terminal 52 may be in contact with a surface on the principal surface 11 side of the circuit wiring 172.

The circuit board 2000 is fabricated by forming the circuit pattern layer 170 and the battery 2001 separately and joining the circuit pattern layer 170 and the battery 2001 thus formed to each other, for example. Alternatively, the circuit board 2000 may be formed by laminating the wiring insulating layer 171 on the battery 2001 and then forming the pattern of the circuit wiring 172 on the laminated wiring insulating layer 171.

According to the above-described circuit board 2000, the electronic device 195 and the electronic device 196 can be mounted on the circuit pattern layer 170 that is formed on the battery 2001. Thus, the wiring board and the battery are integrated together, and downsizing and thin profiling of electronic equipment can be realized. Meanwhile, since the battery 2001 is one of the batteries according to the above-described embodiments, the battery 2001 can achieve a high capacity density and high reliability at the same time.

Meanwhile, the electric power can be directly supplied from the battery 2001 to required locations on the circuit wiring 172. Thus, it is possible to reduce extension of the wiring. Moreover, the counter electrode conductive member 41 and the electrode conductive member 42 provided inside the through holes 20a and the through holes 20b are connected to the circuit wiring 172 on the circuit pattern layer 170 that is laminated on the power generation element. Thus, it is possible to shorten connection distances from the positive electrode and the negative electrode of the power generation element to the circuit wiring 172. Accordingly, it is possible to suppress radiation noise from the wiring. Moreover, the current collectors in the battery 2001 can function as shield layers for noise suppression. As described above, it is possible to stabilize an operation of the electronic equipment by using the circuit board 2000 for the electronic equipment. The circuit board 2000 is used for radio-frequency equipment susceptible to the radiation noise, for example.

Each of the counter electrode conductive member 41 and the electrode conductive member 42 is electrically connected to the circuit wiring 172 while interposing the counter electrode current collecting terminal 51 or the electrode current collecting terminal 52 therebetween. However, the present disclosure is not limited to this configuration. For example, conductive contacts that penetrate the wiring insulating layer 171 may be provided and the circuit wiring 172 may be electrically connected to the counter electrode conductive member 41 and the electrode conductive member 42 while interposing the conductive contacts therebetween.

### Manufacturing Method

Next, a description will be given of methods of manufacturing the batteries according to the respective embodiments mentioned above. Note that the manufacturing methods to be described below are mere examples and the methods of manufacturing the batteries of the above-described embodiments are not limited to the following examples. Meanwhile, the following description will be focused on manufacturing of the battery according to one of the above-mentioned embodiments. However, each of the manufacturing methods described below is applicable to the battery according to a different one of the embodiments as appropriate.

### First Example of Manufacturing Method

A first example of manufacturing the batteries according to the respective embodiments will be described to begin with.

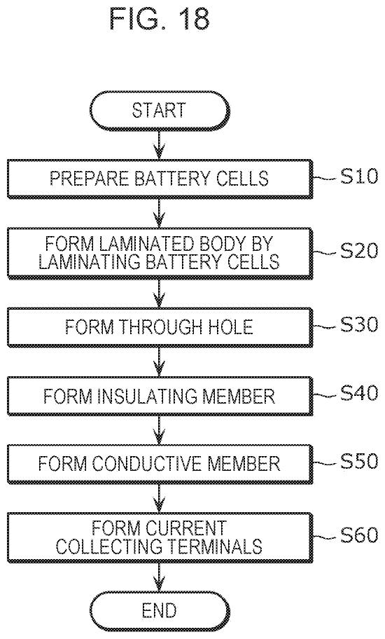

FIG. 18 is a flowchart illustrating the first example of the method for manufacturing the batteries according to the respective embodiments. The first example of the manufacturing method will be focused on manufacturing of the battery 1 according to the Embodiment 1.

As illustrated in FIG. 18, the battery cells are prepared to begin with (step S10). The prepared battery cells are any of the battery cells 100A, battery cells 100B, and the battery cells 100C illustrated in FIGS. 3A to 3C, for example. In the following description of the manufacturing method, the battery cells 100A, 100B, and the 100C may be collectively referred to as the battery cells 100 as appropriate.

Next, a laminated body is formed by laminating the battery cells 100 (step S20). To be more precise, the laminated body is formed by sequentially laminating the battery cells 100 such that the orders of arrangement of the electrode layer 110, the counter electrode layer 120, and the solid electrolyte layer 130 are alternately reversed. The power generation element 5 illustrated in FIG. 4 is formed by laminating an appropriate combination of the battery cells 100A, 100B, and 100C, for example. The power generation element 5 is an example of the laminated body.

Here, the side surfaces of the power generation element 5 may be planarized after laminating the battery cells 100. The power generation element 5 with the respective flat side surfaces can be formed by cutting the laminated body of the battery cells 100 in a lump, for example. A cutting process is carried out by using a blade, a laser, waterjet, and the like.

Next, the respective battery cells 100 are provided with the through holes that penetrate the respective battery cells 100 in the direction of lamination (step S30). To be more precise, each of the battery cells 100 is provided with two through holes, namely, the through hole 20a and the through hole 20b. For example, formation of the through holes 20a and the through holes 20b is carried out by cutting work by using a drill and the like. Alternatively, the through holes 20a and the through holes 20b may be formed by using a laser and the like.

Meanwhile, in the first example of the manufacturing method, the through holes 20a and the through holes 20b are formed after the formation of the laminated body (step S20). To this end, through holes that penetrate the power generation element 5 in the direction of lamination are formed, for example. Thus, the through holes 20a and the through holes 20b are formed in the laminated battery cells 100 in a lump, respectively. In addition, it is not necessary to align the positions in order to concatenate the respective through holes 20a and the respective through holes 20b of the battery cells 100. Thus, productivity can be improved in manufacturing the battery 1. This is especially effective in the case of manufacturing the large-sized battery 1 that needs to improve the positioning accuracy due to an increase in area of the power generation element 5. Moreover, the inner walls 25a of the through holes 20a and the inner walls 25b of the through holes 20b of the battery cells 100 can be easily formed into continuous surfaces, respectively.

Next, the insulating members are provided on the inner walls of the through holes thus formed (step S40). Specifically, the electrode insulating members 31 to cover the respective electrode layers 110 of the battery cells 100 are formed on the inner walls 25a of the through holes 20a formed in the respective battery cells 100. Moreover, the counter electrode insulating members 32 to cover the respective counter electrode layers 120 of the battery cells 100 are formed on the inner walls 25b of the through holes 20b formed in the respective battery cells 100.

Next, the conductive members are provided on the inner walls of the through holes thus formed (step S50). Specifically, the counter electrode conductive member 41 being electrically connected to the counter electrode layer 120 of each of the battery cells 100 is formed on each of the inner walls 25a of the through holes 20a formed in the respective battery cells 100. For example, the counter electrode conductive member 41 is formed in such a way as to cover the electrode insulating member 31 as well as the inner wall 25a of the through hole 20a formed in each of the battery cells 100. Meanwhile, the electrode conductive member 42 being electrically connected to the electrode layer 110 of each of the battery cells 100 is formed on each of the inner walls 25b of the through holes 20b formed in the respective battery cells 100. For example, the electrode conductive member 42 is formed in such a way as to cover the counter electrode insulating member 32 as well as the inner wall 25b of the through hole 20b formed in each of the battery cells 100. In the meantime, the connecting member 50 is formed as appropriate at the end portion on the principal surface 12 side of the counter electrode conductive member 41 and at the position to be connected to the principal surface 12.

In the first example of the manufacturing method, the insulating members and the conductive members may be formed by inserting the first composite member illustrated in FIG. 5B and the second composite member illustrated in FIG. 5D, respectively, into the through holes 20a and the through holes 20b corresponding thereto. As described above, in the first example of the manufacturing method, the formation of the insulating members (step S40) and the formation of the conductive members (step S50) may be carried out at the same time.

Meanwhile, in steps S30, S40, and S50, the through holes 20a, the electrode insulating members 31, and the counter electrode conductive member 41 may be formed in the first place and the through hole 20b, the counter electrode insulating members 32, and the electrode conductive member 42 may be formed thereafter.

Next, the current collecting terminals are formed (step S60). Specifically, the counter electrode current collecting terminal 51 is formed at such a position that is connected to the end portion on the principal surface 11 side of the counter electrode conductive member 41 and is not in contact with the principal surface 11. Meanwhile, the electrode current collecting terminal 52 is formed to be connected to the end portion on the principal surface 11 side of the electrode conductive member 42. The counter electrode current collecting terminal 51 and the electrode current collecting terminal 52 are formed by disposing the conductive material at desired regions by printing, plating, soldering, and the like.

The battery 1 illustrated in FIG. 1 can be manufactured by carrying out the above-described steps.

Meanwhile, the side surface insulating layer 60 illustrated in FIG. 6 may be formed at a certain timing after the formation of the laminated body (step S20). The side surface insulating layer 60 is formed by coating the insulating material on the side surfaces and the like of the power generation element 5, for example. The side surface insulating layer 60 may be formed by dipping a portion of the power generation element 5 into the insulating material in liquid form, and then curing the insulating material adhering to the power generation element 5. The curing is carried out by drying, heating, light irradiation, and the like depending on the resin material used therein.

In the meantime, the sealing member 90 illustrated in FIGS. 14, 15, and 16 may be formed after the formation of the counter electrode current collecting terminal (step S60). The sealing member 90 is formed by coating the resin material having fluidity and then curing the resin material, for example. The coating is carried out in accordance with an ink jet method, a spray method, a screen printing method, a gravure printing method, and the like. The curing is carried out by drying, heating, light irradiation, and the like depending on the resin material used therein.

### Second Example of Manufacturing Method

Next, a second example of manufacturing the batteries according to the respective embodiments will be described. The following description will be focused on different features from those of the first example of the manufacturing method while omitting or simplifying explanations of features in common.

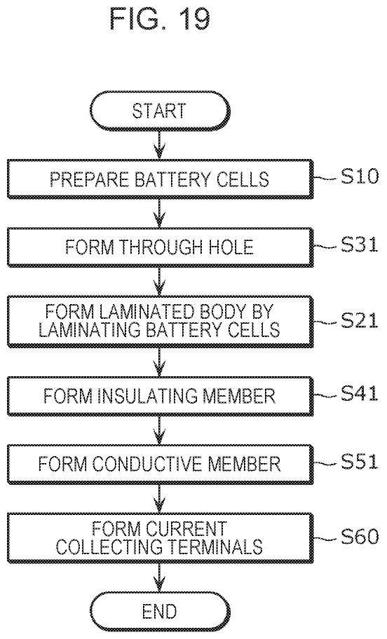

FIG. 19 is a flowchart illustrating the second example of the method for manufacturing the batteries according to the respective embodiments. The second example of the manufacturing method will be focused on manufacturing of the battery 401 according to the Embodiment 4. The second example of the manufacturing method has the different order of the respective steps from that of the first example of the manufacturing method.

As illustrated in FIG. 19, the battery cells are first prepared in accordance with the same method as that of the first example of the manufacturing method (step S10).

Next, the respective battery cells 100 are provided with the through holes that penetrate the respective battery cells 100 in the direction of lamination (step S31). Specifically, the battery cells 100 are individually provided with the through holes 320a and the through holes 320b having the same shape. For example, the through holes 320a and the through holes 320b are formed in accordance with the methods described with reference to FIGS. 9A and 10A. As described above, the through hole 320a and the through hole 320b can be formed in each of the battery cells 100, so that the through holes can be formed easily and freedom of the shapes of the through holes is increased. The respective battery cells 100 may be provided with through holes having shapes that are different from one another. The cutting work or the like similar to that in the first example of the manufacturing method can be used as the method of forming the through holes 320a and the through holes 320b.

Next, a laminated body is formed by laminating the battery cells 100 (step S21). In step S21, the battery cells 100 are laminated in such a way as to concatenate the through holes 320a formed in the respective battery cells 100 and to concatenate the through holes 320b formed in the respective battery cells 100.

Next, the insulating members are provided on the inner walls of the through holes thus formed (step S41). Then, the conductive members are provided on the inner walls of the through holes thus formed (step S51). In this way, the insulating members and the conductive members can be formed in the respective through holes of the battery cells 100 in a lump, so that productivity can be improved.

In steps S21, S41, and S51, the through holes, the insulating members, and the conductive members are formed in accordance with the methods described with reference to FIGS. 12A to 12D, for example.

Next, the current collecting terminals are formed in accordance with the same method as that in the first example of the manufacturing method (step S60).

The battery 401 illustrated in FIG. 11 can be manufactured by carrying out the above-described steps.

Here, the battery 1 according to the Embodiment 1 may be manufactured by providing the respective battery cells 100 with the through holes 20a and the through holes 20b in step S31. In this case, steps S41 and S51 are carried out in accordance with the same methods as steps S40 and S50 in the first example of the manufacturing method.

### Third Example of Manufacturing Method

Next, a third example of manufacturing the batteries according to the respective embodiments will be described. The following description will be focused on different features from those of the first and second examples of the manufacturing method while omitting or simplifying explanations of features in common.

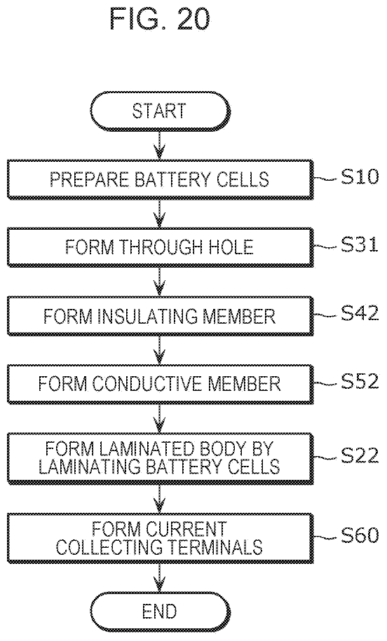

FIG. 20 is a flowchart illustrating the third example of the method for manufacturing the batteries according to the respective embodiments. The third example of the manufacturing method will be focused on the manufacturing of the battery 301 according to the Embodiment 3. The third example of the manufacturing method has the different order of the respective steps from those of the first and second examples of the manufacturing method.

As illustrated in FIG. 20, the battery cells are first prepared in accordance with the same method as that of the first example of the manufacturing method (step S10).

Next, the respective battery cells 100 are provided with the through holes that penetrate the respective battery cells 100 in the direction of lamination in accordance with the same method as that in the second example of the manufacturing method (step S31).

Next, the insulating members are provided on the inner walls of the through holes thus formed (step S42). In step S42, the electrode insulating member 331 to cover the electrode layer 110 is formed on each inner wall 325a and the counter electrode insulating member 332 to cover the counter electrode layer 120 is formed on each inner wall 325b in accordance with the methods described with reference to FIGS. 9B and 10B, for example.

Next, the conductive members are provided on the inner walls of the through holes thus formed (step S52). Specifically, the counter electrode conductive member 341 to be electrically connected to the counter electrode layer 120 on the inner wall 325a is individually formed inside the through hole 320a provided to each of the battery cells 100. For example, the counter electrode conductive member 341 is formed by filling a space inside the through hole 320a, which is formed in each battery cell 100 and not provided with the electrode insulating member 331, with the conductive material. Meanwhile, the electrode conductive member 342 to be electrically connected to the electrode layer 110 on the inner wall 325b is individually formed inside the through hole 320b provided to each of the battery cells 100. For example, the electrode conductive member 342 is formed by filling a space inside the through hole 320b, which is formed in each battery cell 100 and not provided with the counter electrode insulating member 332, with the conductive material.

As described above, the insulating members and the conductive member can be formed in each of the through holes before laminating the battery cells 100. Accordingly, it is easy to carry out an operation such as insertion of the materials into the through holes, so that the insulating members and the conductive members can be formed easily and accurately.

Next, a laminated body is formed by laminating the battery cells 100 (step S22). In step S22, the battery cells 100 are laminated in such a way as to concatenate the through holes 320a formed in the respective battery cells 100 and to concatenate the through holes 320b formed in the respective battery cells 100. Moreover, the battery cells 100 are laminated in such a way as to connect the counter electrode conductive members 341 formed in the respective through holes 320a of the battery cells 100 to one another and to connect the electrode conductive members 342 formed in the respective through holes 320b of the battery cells 100 to one another.

Next, the counter electrode current collecting terminalis formed in accordance with the same method as that of the first example of the manufacturing method (step S60).

The battery 301 illustrated in FIG. 8 can be manufactured by carrying out the above-described steps.

### Fourth Example of Manufacturing Method

Next, a fourth example of manufacturing the batteries according to the respective embodiments will be described. The following description will be focused on different features from those of the first to third examples of the manufacturing method while omitting or simplifying explanations of features in common.

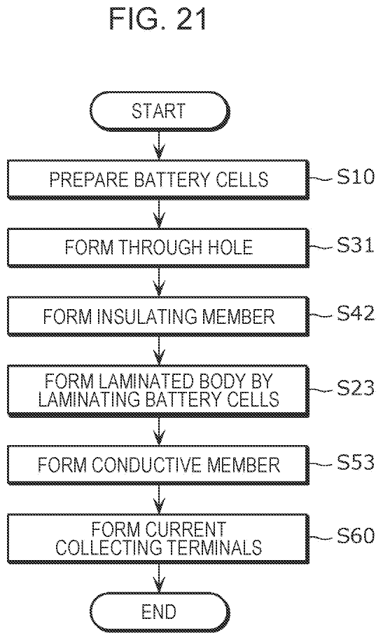

FIG. 21 is a flowchart illustrating the fourth example of the method for manufacturing the batteries according to the respective embodiments. The fourth example of the manufacturing method will be focused on the manufacturing of the battery 301 according to the Embodiment 3. The fourth example of the manufacturing method has the different order of the respective steps from those of the first to third examples of the manufacturing method.

As illustrated in FIG. 21, the battery cells are first prepared in accordance with the same method as that of the first example of the manufacturing method (step S10).

Next, the respective battery cells 100 are provided with the through holes that penetrate the respective battery cells 100 in the direction of lamination in accordance with the same method as that in the second example of the manufacturing method (step S31).

Next, the insulating members are provided on the inner walls of the through holes thus formed in accordance with the same method as that in the third example of the manufacturing method (step S42). In this way, the electrode insulating members 331 and the counter electrode insulating member 332, which are required to be formed accurately in order to improve reliability of the battery 301, can be formed easily and accurately.

Next, a laminated body is formed by laminating the battery cells 100 (step S23). In step S23, the battery cells 100 are laminated in such a way as to concatenate the through holes 320a formed in the respective battery cells 100 and to concatenate the through holes 320b formed in the respective battery cells 100.

Next, the conductive members are provided on the inner walls of the through holes thus formed (step S53). Specifically, the counter electrode conductive members 341 to be electrically connected to the counter electrode layers 120 on the inner walls 325a are formed in a lump inside the respective through holes 320a provided to the battery cells 100. For example, each counter electrode conductive member 341 is formed by filling a space inside the through hole 320a, which is formed in each of the battery cells 100 and not provided with the electrode insulating member 331, with the conductive material. Meanwhile, the electrode conductive members 342 to be electrically connected to the electrode layers 110 on the inner walls 325b are formed in a lump inside the respective through holes 320b provided to the battery cells 100. For example, each electrode conductive member 342 is formed by filling a space inside the through hole 320b, which is formed in each of the battery cells 100 and not provided with the counter electrode insulating member 332, with the conductive material.

Next, the current collecting terminals are formed in accordance with the same method as that in the first example of the manufacturing method (step S60).

The battery 301 illustrated in FIG. 8 can be manufactured by carrying out the above-described steps.

Here, the laminated body as illustrated in FIG. 12B may be formed in step S23 by filling the through holes 320a and the through holes 320b with the insulating member in step S42. In this way, it is also possible to manufacture the battery 401 according to the Embodiment 4 by using the same methods as those starting from step S41 in the second example of the manufacturing method.

### OTHER EMBODIMENTS

The battery, the method for manufacturing the battery, and the circuit board according to one or more aspects have been described above based on the embodiments. However, the present disclosure is not limited to these embodiments. Various modifications that can be conceived of by those skilled in the art and are adopted to any of these embodiments as well as other aspects constructed by combining certain constituents out of the embodiments are also encompassed by the scope of the present disclosure as long as those modifications and modes do not depart from the gist of the present disclosure.

For example, the above-described embodiments depict the example in which the single current collector is shared by the battery cells located adjacent to each other as any of the electrode current collector and the counter electrode current collector. However, the current collector does not need to be shared. Here, two adjacent battery cells may be laminated together while joining two current collector to each other.

Meanwhile, in the above-described embodiments, the counter electrode current collecting terminal and the electrode current collecting terminal are provided on the same principal surface side of the power generation element, for example. However, the present disclosure is not limited to this configuration. The counter electrode current collecting terminal and the electrode current collecting terminal may be provided on the principal surfaces different from each other. In this case, it is possible to form a structure that enables strong connection to external equipment and the like by using external terminals designed to sandwich from two sides in the direction of lamination.

In the meantime, in the above-described embodiments, each of the connection of the respective electrode layers and the electrical connection of the counter electrode layers of the battery cells is established by using the conductive member inside the through holes. However, the present disclosure is not limited to this configuration. For example, the electrical connection of the respective counter electrode layers of the battery cells may be carried out on the outside of the power generation element by using a side surface of the power generation element.

In the meantime, in any of the above-described embodiments, an external electrode may further be formed on any of the current collecting terminals by plating, printing, soldering, and the like, for example. The formation of the external electrode can further enhance mountability of the battery, for example.

In the meantime, in the above-described embodiments, the electrode insulating members and the counter electrode conductive member are formed inside the first through hole while the counter electrode insulating members and the electrode conductive member are formed inside the second through holes. However, the present disclosure is not limited to this configuration. For instance, a relatively large through hole may be provided to each of the battery cells, and the electrode insulating members and the counter electrode conductive member may be formed in a portion of a space in the through hole while the counter electrode insulating members and the electrode conductive member may be formed in another portion of the space in the through hole.

Meanwhile, the battery includes the counter electrode current collecting terminal and the electrode current collecting terminal in the above-described embodiments, for example. However, the present disclosure is not limited to this configuration. The battery does not always have to include at least one of the counter electrode current collecting terminal and the electrode current collecting terminal. For example, a current may be extracted from the battery by connecting terminals of an electronic device, contacts of a board, pads of the board, and the like to the counter electrode conductive member and the electrode conductive member.

Meanwhile, the respective embodiments described above can implement a variety of modification, replacement, addition, omission, and the like within the scope of the appended claims and the equivalents thereof.

The present disclosure is applicable to a battery or a circuit board for electronic equipment, electric appliances, and electric vehicles, for example.

What is claimed is:

1. A battery comprising:
a power generation element including a plurality of battery cells each having an electrode layer, a counter electrode layer, and a solid electrolyte layer located between the electrode layer and the counter electrode layer, the plurality of battery cells being laminated while being electrically connected in parallel;
an electrode insulating member; and
a counter electrode conductive member, wherein
each of the plurality of battery cells is provided with a first through hole penetrating in a direction of lamination,
the electrode insulating member covers the electrode layer of each of the plurality of battery cells on an inner wall of the first through hole of each of the plurality of battery cells, and
the counter electrode conductive member is electrically connected to the counter electrode layer of each of the plurality of battery cells on the inner wall of the first through hole of each of the plurality of battery cells.

2. The battery according to claim 1, wherein a sectional shape of the first through hole at the electrode layer in a direction perpendicular to the direction of lamination is different from a sectional shape of the first through hole at the counter electrode layer in the direction perpendicular to the direction of lamination.

3. The battery according to claim 1, wherein a sectional area of the first through hole at the electrode layer in a direction perpendicular to the direction of lamination is larger than a sectional area of the first through hole at the counter electrode layer in the direction perpendicular to the direction of lamination.

4. The battery according to claim 1, wherein an inner side surface of the electrode layer is inclined with respect to the direction of lamination on the inner wall of the first through hole.

5. The battery according to claim 4, wherein at least a portion of an inner side surface of the counter electrode layer is parallel to the direction of lamination on the inner wall of the first through hole.

6. The battery according to claim 1, wherein the first through hole includes a truncated cone shape.

7. The battery according to claim 1, wherein volumes of the respective first through holes of the plurality of battery cells are equal.

8. The battery according to claim 1, wherein the inner walls of the respective first through holes of the plurality of battery cells form a continuous surface.

9. The battery according to claim 1, wherein the first through holes of at least a portion of battery cells among the plurality of battery cells are concatenated.

10. The battery according to claim 9, wherein, in the power generation element,
a portion of the plurality of battery cells constitutes a first cell laminated body by being laminated in such a way as to concatenate the first through holes,
another portion of the plurality of battery cells constitutes a second cell laminated body by being laminated in such a way as to concatenate the first through holes, and
a position of the first through holes in the first cell laminated body is different from a position of the first through holes in the second cell laminated body when viewed in the direction of lamination.

11. The battery according to claim 9, wherein the first through holes of all battery cells out of the plurality of battery cells are concatenated.

12. The battery according to claim 1, wherein
each of the plurality of battery cells is provided with a second through hole penetrating in the direction of lamination, and
the battery further includes
a counter electrode insulating member that covers the counter electrode layer of each of the plurality of battery cells on an inner wall of the second through hole of each of the plurality of battery cells, and
an electrode conductive member that is electrically connected to the electrode layer of each of the plurality of battery cells on the inner wall of the second through hole of each of the plurality of battery cells.

13. A method for manufacturing a battery comprising:
forming a laminated body by sequentially laminating a plurality of battery cells each including an electrode layer, a counter electrode layer, and a solid electrolyte layer located between the electrode layer and the counter electrode layer, in such a way that orders of arrangement of the electrode layer, the counter electrode layer, and the solid electrolyte layer included in each of the plurality of battery cells are alternately reversed;
forming a through hole in each of the plurality of battery cells in such a way as to penetrate in a direction of lamination;
forming an electrode insulating member on an inner wall of the through hole formed in each of the plurality of battery cells in such a way as to cover the electrode layer of each of the plurality of battery cells; and
forming a counter electrode conductive member on the inner wall of the through hole formed in each of the plurality of battery cells in such a way as to be electrically connected to the counter electrode layer of each of the plurality of battery cells.

14. The method for manufacturing a battery according to claim 13, wherein the forming a through hole is carried out after the forming a laminated body.

15. The method for manufacturing a battery according to claim 13, wherein
in the forming a laminated body, the plurality of battery cells are laminated after the forming a through hole in such a way as to concatenate the through holes formed in the plurality of battery cells, respectively, and
the method for manufacturing a battery carries out the forming an electrode insulating member and the forming a counter electrode conductive member after the forming a laminated body.

16. The method for manufacturing a battery according to claim 15, wherein
in the forming a through hole, the through hole is formed such that a sectional area of the through hole at the electrode layer in a direction perpendicular to the direction of lamination is larger than a sectional area of the through hole at the counter electrode layer in the direction perpendicular to the direction of lamination,
in the forming an electrode insulating member, the through hole formed in each of the plurality of battery cells is filled with an insulating member, and a columnar hole extending in a direction of concatenation of the through holes and having a sectional area smaller than the sectional area of the through hole at the electrode layer in the direction perpendicular to the direction of lamination and larger than the sectional area of the through hole at the counter electrode layer in the direction perpendicular to the direction of lamination is formed in a region including the filled insulating member, so as to form the electrode insulating member by using a remaining portion of the insulating member and to expose the counter electrode layer of each of the plurality of battery cells, and
in the forming a counter electrode conductive member, the counter electrode conductive member is formed by filling the columnar hole with a conductive material.

17. The method for manufacturing a battery according to claim 13, wherein the method for manufacturing a battery carries out the forming a through hole, the forming an electrode insulating member, and the forming a counter electrode conductive member before the forming a laminated body.

18. The method for manufacturing a battery according to claim 13, wherein the method for manufacturing a battery carries out the forming a through hole and the forming an electrode insulating member before the forming a laminated body, and carried out the forming a counter electrode conductive member after the forming a laminated body.

19. A circuit board comprising:
a power generation element including a plurality of battery cells each having an electrode layer, a counter electrode layer, and a solid electrolyte layer located between the electrode layer and the counter electrode layer, the plurality of battery cells being laminated while being electrically connected in parallel;
an electrode insulating member;
a counter electrode conductive member; and
a circuit pattern layer being laminated on the power generation element and including circuit wiring, wherein
each of the plurality of battery cells is provided with a first through hole penetrating in a direction of lamination,
the electrode insulating member covers the electrode layer of each of the plurality of battery cells on an inner wall of the first through hole of each of the plurality of battery cells, and
the counter electrode conductive member is electrically connected to the counter electrode layer of each of the plurality of battery cells on the inner wall of the first through hole of each of the plurality of battery cells, and is electrically connected to a portion of the circuit wiring.

20. The circuit board according to claim 19, wherein
each of the plurality of battery cells is provided with a second through hole penetrating in the direction of lamination, and
the circuit board further includes
a counter electrode insulating member that covers the counter electrode layer of each of the plurality of battery cells on an inner wall of the second through hole of each of the plurality of battery cells, and
an electrode conductive member that is electrically connected to the electrode layer of each of the plurality of battery cells on the inner wall of the second through hole of each of the plurality of battery cells, and is electrically connected to another portion of the circuit wiring.
